(19) United States
(12) Patent Application Publication
(10) Pub. No.: US 2026/0087370 A1
(43) Pub. Date: Mar. 26, 2026

(54) SELF-SUPERVISED QUANTIZATION-AWARE KNOWLEDGE DISTILLATION FOR NEURAL NETWORKS

(71) Applicants: Kaiqi Zhao, Rochester, MI (US); Ming Zhao, San Jose, CA (US)

(72) Inventors: Kaiqi Zhao, Rochester, MI (US); Ming Zhao, San Jose, CA (US)

(73) Assignee: Arizona Board of Regents on Behalf of Arizona State University, Scottsdale, AZ (US)

(21) Appl. No.: 19/333,027

(22) Filed: Sep. 18, 2025

Related U.S. Application Data
(60) Provisional application No. 63/697,015, filed on Sep. 20, 2024.

(51) Int. Cl. G06N 3/096; G06N 3/0495

(52) U.S. Cl. CPC G06N 3/096; G06N 3/0495

(57) ABSTRACT

A system may be configured to train an artificial intelligence model (AI model). For example, the system, using a training framework with both a teacher layer and a student layer provides target outputs from the teacher layer, while the student layer learns to approximate these outputs. The system may obtain input data and, using the training framework, train the AI model using the input data. For example, the training framework defines a quantizer with clipping and rounding functions to convert full-precision data to quantized data. The framework calculates a first output distribution from the teacher layer and a second output distribution from the student layer. A training loss is computed between these distributions, and parameters of the quantized network are adjusted to minimize discretization error and prediction discrepancy. The trained quantized network is then used to generate new predictive outputs from the AI model.

### CLAIM OF PRIORITY

This application claims the benefit of U.S. Patent Application No. 63/697,015, filed 20 Sep. 2024, the entire contents of which is incorporated herein by reference.

### GOVERNMENT RIGHTS AND GOVERNMENT AGENCY SUPPORT NOTICE

This invention was made with government support under 2311026, 2231874, 2126291 and 1955593 awarded by the National Science Foundation. The government has certain rights in the invention.

### TECHNICAL FIELD

Aspects of the invention relate generally to the fields of machine learning (ML) and artificial intelligence modeling.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

Quantization reduces the computational demands of neural networks by approximating weights and activations with lower precision values. Common approaches include Post-Training Quantization (PTQ) and Quantization-Aware Training (QAT). PTQ applies quantization to a model after training, while QAT integrates quantization during the training process. Some QAT methods employ channel-wise scaling, and other techniques, such as PACT and LSQ, introduce trainable parameters to control quantization ranges and intervals.

Knowledge Distillation (KD) involves transferring knowledge from a larger model, referred to as a teacher, to a smaller model, referred to as a student. The approach introduced by Hinton et al. minimized the divergence between the teacher's and student's SoftMax outputs along with cross-entropy loss relative to data labels. Other work expanded KD to include transfer of intermediate representations, such as feature similarity matrices and attention maps. KD has been applied in a variety of machine learning tasks, including image classification.

### SUMMARY

In general, this disclosure is directed to systems, methods, and apparatuses for implementing a Self-Supervised Quantization-Aware Knowledge Distillation (SQAKD) framework for training artificial intelligence networks (AI networks).

The SQAKD framework establishes a comprehensive approach for Quantization-Aware Training (QAT) by treating QAT as a constrained optimization problem. The SQAKD framework integrates various quantization techniques, involving both forward and backward propagation dynamics. The forward process converts full-precision inputs into quantized outputs using clipping and rounding functions, with different quantizers such as Parameterized Clipping Activation for Quantization (PACT) and Error Weight Gradient Scheme (EWGS) employing specific parameter schemes. Backward propagation addresses challenges from non-differentiable quantizers by using a modified gradient approximation approach that incorporates discretization error.

In optimizing QAT, the described SQAKD framework emphasizes minimizing both discretization error and prediction discrepancies. Evaluations show that traditional Knowledge Distillation (KD) methods may underperform in quantized settings due to reduced network capacity and noise. The SQAKD framework may utilize a Kullback-Leibler type divergence loss (KL-loss) rather than combining it with Cross-Entropy (CE) loss. This approach improves performance by simplifying the loss function and enhancing the quantization process, validated across various models and datasets. In other examples, KL losses are combined with CE losses.

In at least one example, processing circuitry is configured to perform a method including: obtaining input data for training an artificial intelligence model (AI model) and providing the input data into a training framework having both a teacher layer providing target outputs and a student layer configured to learn to approximate the target outputs. In some examples, the method includes training the AI model using the training framework, wherein training the AI model includes defining a quantizer that includes a clipping function and a rounding function to convert full-precision data derived from the input data to quantized data. The method may also include determining a first output distribution for the input data from the teacher layer of the training framework using the full-precision data. In at least one example, the method includes determining a second output distribution for the input data from the student layer of the training framework using the quantized data, calculating a training loss between the first output distribution from the teacher layer and the second output distribution from the student layer, and modifying training parameters of a quantized network of the student layer to reduce discretization error and prediction discrepancy between the quantized network of the student layer and a full-precision network of the teacher layer. According to such an example, the method may also include generating new predictive output from the AI model using the quantized network of the student layer trained on the input data using the training framework and outputting the predictive output.

In at least one example, a system includes processing circuitry; non-transitory computer readable media; and instructions that, when executed by the processing circuitry, configure the processing circuitry to perform operations. In such an example, processing circuitry may configure the system to obtain, by the processing circuitry, input data for training an artificial intelligence model (AI model) and provide, by the processing circuitry, the input data into a training framework having both a teacher layer providing target outputs and a student layer configured to learn to approximate the target outputs. The instructions may also configure the processing circuitry to train the AI model using the training framework, wherein to train the AI model includes the instructions, when executed, to further configure the processing circuitry to define, using the training framework, a quantizer that includes a clipping function and a rounding function to convert full-precision data derived from the input data to quantized data. The instructions may configure the processing circuitry to determine, using the training framework, a first output distribution for the input data from the teacher layer of the training framework using the full-precision data, determine, using the training framework, a second output distribution for the input data from the student layer of the training framework using the quantized data, and calculate, using the training framework, a training loss between the first output distribution from the teacher layer and the second output distribution from the student layer. In at least one example, the instructions configure the processing circuitry to modify, using the training framework, training parameters of a quantized network of the student layer to reduce discretization error and prediction discrepancy between the quantized network of the student layer and a full-precision network of the teacher layer. According to such an example, the instructions also configure the processing circuitry to generate new predictive output from the AI model using the quantized network of the student layer trained on the input data using the training framework and output the predictive output.

In one example, there is computer-readable storage media having instructions that, when executed, configure processing circuitry to: obtain input data for training an artificial intelligence model (AI model). The instructions, when executed, may configure the processing circuitry to provide the input data into a training framework having both a teacher layer providing target outputs and a student layer configured to learn to approximate the target outputs. The instructions, when executed, may also configure the processing circuitry to train the AI model using the training framework. In such an example, the instructions, when executed, configure the processing circuitry to: define a quantizer that includes a clipping function and a rounding function to convert full-precision data derived from the input data to quantized data, determine a first output distribution for the input data from the teacher layer of the training framework using the full-precision data, and determine a second output distribution for the input data from the student layer of the training framework using the quantized data. In at least one example, the instructions, when executed, configure the processing circuitry to calculate a training loss between the first output distribution from the teacher layer and the second output distribution from the student layer and modify training parameters of a quantized network of the student layer to reduce discretization error and prediction discrepancy between the quantized network of the student layer and a full-precision network of the teacher layer. In such an example, the instructions, when executed, further configure the processing circuitry to generate new predictive output from the AI model using the quantized network of the student layer trained on the input data using the training framework and output the predictive output.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of a computing device, in accordance with aspects of this disclosure.

FIG. 2 depicts Table 1 at an element as a comparison table that summarizes related works applying knowledge distillation to quantization-aware training, in accordance with aspects of the disclosure.

FIG. 3 is a conceptual diagram depicting the workflow of a SOAKD framework, in accordance with aspects of the disclosure.

FIGS. 4A and 4B illustrate the evolution of CE-Loss and KL-Loss during training of a 1-bit VGG-13 network on CIFAR, in accordance with aspects of the disclosure.

FIG. 5 depicts Table 2 at an element including a models and datasets table, which provides a summary of models and datasets, in accordance with aspects of the disclosure.

FIG. 6 depicts an algorithm block providing example pseudocode for self-supervised quantization-aware knowledge distillation, in accordance with aspects of the disclosure.

FIG. 7 depicts a baselines table at an element providing a summary of baselines, in accordance with aspects of the disclosure.

FIGS. 8A, 8B, 8C, and 8D illustrate the evolution of top-1 test accuracy of full-precision and quantized models using EWGS and SQAKD integrating EWGS during training, in accordance with aspects of the disclosure.

FIG. 9A depicts Table 4 at an element providing a summary of top-1 test accuracy on CIFAR-10, in accordance with aspects of the disclosure.

FIG. 9B depicts Table 4 at an element providing a summary of top-1 test accuracy on CIFAR, in accordance with aspects of the disclosure.

FIG. 10 depicts Table 5 providing a summary of top-1 test accuracy of a ResNet-18 column and a VGG-11 column on Tiny-ImageNet, in accordance with aspects of the disclosure.

FIG. 11 depicts Table 6 at an element providing a summary of top-1 accuracy and top-5 accuracy values for a MobileNet-V2, a ShuffleNet-V2, and a SqueezeNet on Tiny-ImageNet, in accordance with aspects of the disclosure.

FIG. 12 depicts Table 7 at an element providing a summary of top-1 test accuracy of knowledge distillation in quantization-aware training, using EWGS as the quantizer, in accordance with aspects of the disclosure.

FIGS. 13A, 13B, and 13C provide an illustration of a top-1 test accuracy axis, a CE-loss axis, and a KL-loss axis of EWGS, FSP, and SQAKD curve in each epoch axis or iteration axis during training on 2-bit ResNet-20 with CIFAR-10, in accordance with aspects of the disclosure.

FIG. 14 depicts Table 8 at an element providing a comparison of a SQAKD framework with KD-integrated QAT methods, in accordance with aspects of the disclosure.

FIG. 15 depicts Table 9 at an element providing a summary of inference throughput, inference time, and speedup results across different deep learning models on Jetson Nano, in accordance with aspects of the disclosure.

FIG. 16 depicts Table 10 at an element providing a summary of top-1 test accuracy of different quantization forward and backward combinations, in accordance with aspects of the disclosure.

FIGS. 17A and 17B depict 3D loss surfaces, quantized loss landscape, 2D contours, and quantized loss projection, in accordance with aspects of the disclosure.

FIGS. 18A and 18B depict the effect of temperature on test accuracy as illustrated by temperature at FIG. 18A, and the effect of initialization strategy as illustrated by quantization method at FIG. 18B, in accordance with aspects of the disclosure.

FIG. 19 depicts Table 11 at an element providing a summary of implementation details for the various datasets and models, in accordance with aspects of the disclosure.

FIG. 20 depicts Table 12 at an element providing a summary of the hyperparameters of related KD methods, in accordance with aspects of the disclosure.

FIGS. 21A, 21B, 21C, and 21D provide an illustration of a top-1 test accuracy evolution of full-precision models and quantized models using SQAKD and the standalone quantization methods, in accordance with aspects of the disclosure.

FIG. 22 depicts a y-axis top-1 test accuracy, in accordance with aspects of the disclosure.

FIGS. 23A and 23B depict the evolution of a y-axis CE-Loss and a y-axis KL-Loss, respectively, as a function of an x-axis iteration during the training of 1-bit VGG-13 on CIFAR, in accordance with aspects of the disclosure.

FIGS. 24A-24L illustrate comparative loss surface visualizations for full-precision, standalone EWGS, and a SQAKD framework integrating EWGS, in accordance with aspects of the disclosure.

FIG. 25 is a flow diagram illustrating an example method for training and applying an artificial intelligence model using a teacher-student quantization framework, in accordance with aspects of the disclosure.

Like reference characters denote like elements throughout the text and figures.

### DETAILED DESCRIPTION

Aspects of the disclosure are generally related to systems, methods, and apparatuses for implementing self-supervised quantization-aware knowledge distillation.

Aspects of the disclosure implement an Artificial Intelligence (AI) modeling framework which combines Quantization-aware training (QAT) and Knowledge Distillation (KD) to achieve competitive performance in developing low-bit deep learning models. Prior known techniques that apply KD to QAT require extensive hyper-parameter tuning to balance the weights of various loss terms, assume the availability of labeled training data, and involve complex, computationally intensive training procedures to attain optimal performance.

To address these limitations, a Self-Supervised Quantization-Aware Knowledge Distillation (SQAKD) framework is described. According to aspects of the disclosure, the SQAKD framework unifies the forward and backward dynamics of different quantization functions, allowing flexibility in incorporating various QAT methods. The SQAKD framework may subsequently formulate QAT as a co-optimization problem, simultaneously minimizing the KL-Loss between the full-precision and low-bit models for KD and the discretization error for quantization, without relying on label supervision.

Experiments described below demonstrate that the SQAKD framework significantly outperforms state-of-the-art QAT and KD methods across a range of model architectures.

### INTRODUCTION

Deep neural networks (DNNs) present substantial computational and memory demands. As deep learning technology rapidly advances across a diverse range of Internet of Things (IoT) devices, the disparity between the resource-intensive requirements of DNNs and the constraints of these devices intensifies. Quantization addresses this challenge by converting full-precision model weights or activations to lower precision. Specifically, Quantization-Aware Training (QAT) has shown promise in generating low-bit models. QAT begins with a pre-trained model and performs quantization during retraining. Despite its advantages, many QAT approaches result in significant accuracy loss due to quantization, and no algorithm consistently delivers optimal performance across various model architectures, such as VGG, ResNet, and MobileNet. Furthermore, the diverse motivations behind QAT methods lack a unified theoretical framework, making generalization challenging. Empirical evidence indicates that existing QAT techniques perform poorly on low-bit networks (1-3 bits). Therefore, a need exists for a generalized, simple yet effective framework that can integrate and enhance various QAT algorithms for both low-bit and high-bit quantization.

Recent advancements involve applying Knowledge Distillation (KD) to QAT to alleviate accuracy loss in low-precision networks (referred to as “students”) by transferring knowledge from high-precision networks (referred to as “teachers”) during training. However, KD-applied QAT methods present several challenges: they require extensive hyperparameter tuning to balance different loss terms, assume the availability of labeled training data—which is often difficult or infeasible to obtain in practice—necessitate complex and computationally intensive training procedures for optimal performance, and focus narrowly on specific KD approaches and quantizers, which do not consistently perform well.

Self-Supervised Quantization-Aware Knowledge Distillation framework 170 (SQAKD framework 170) is described in greater detail below. According to aspects of the disclosure, SQAKD framework 170 unifies the forward and backward dynamics of various quantization functions and formulates quantization-aware training as an optimization problem that minimizes the discretization error between original weights/activations and their quantized counterparts. An in-depth analysis of the QAT loss landscape reveals that cross-entropy loss (CE-Loss) does not effectively cooperate with KL-Loss (the Kullback-Leibler divergence loss between the teacher's and student's penultimate outputs), and their combination may degrade network performance. SQAKD framework 170 introduces a formulation of QAT as a co-optimization problem, minimizing both KL-Loss and discretization error for quantization without label supervision.

Compared to existing QAT methods and those integrating KD with QAT, SQAKD framework 170 offers several advantages. First, SQAKD framework 170 provides flexibility by unifying the optimization of various QAT methods. Second, SQAKD framework 170 enhances the state-of-the-art (SOTA) QAT methods by improving both convergence speed and accuracy, using the full-precision teacher's guidance to refine gradient updates for low-bit weights. Third, SQAKD framework 170 eliminates the need for hyperparameter tuning by using only KL-Loss as the training loss. Fourth, SQAKD framework 170 operates in a self-supervised manner without requiring labeled data, making it suitable for a broad range of practical applications. Lastly, SQAKD framework 170 simplifies training procedures by requiring only one training phase, thereby reducing training costs and improving usability and reproducibility.

A comprehensive evaluation demonstrates that SQAKD framework 170 significantly outperforms SOTA QAT and KD methods across various model architectures, including VGG, ResNet, MobileNet-V2, ShuffleNet-V2, and SqueezeNet. SQAKD framework 170 improves convergence speed and top-1 accuracy by up to 15.86% for 1-8 bit quantization compared to methods such as EWGS, PACT, LSQ, and DoReFa. It also outperforms 11 KD methods by up to 17.09% on 1-bit VGG-13 with CIFAR-100 and achieves the smallest accuracy drop compared to KD-integrated QAT methods, outperforming baselines by up to 3.06% on 2-bit ResNet-32 with CIFAR-100. Additionally, SQAKD framework 170 provides an inference speedup of 3× on Jetson Nano hardware for 8-bit quantization on TinyImageNet.

In such a way, SQAKD framework 170 as described in greater detail below provides at least the following contributions: First, a quantitative investigation and benchmarking of 11 KD methods within the context of QAT are conducted, along with an in-depth analysis of the KD loss landscape in QAT. Second, the Self-Supervised Quantization-Aware Knowledge Distillation (SQAKD framework 170) is introduced, which operates in a self-supervised manner without labeled data and eliminates the need for hyperparameter balancing. SQAKD framework 170 effectively incorporates various quantizers and consistently outperforms state-of-the-art QAT, KD, and KD-integrated QAT methods across different models and datasets. Third, all quantized networks, including those with no accuracy loss such as 2-bit VGG-8, 4-bit ResNet-32, and 8-bit MobileNet-V2, are open-sourced, achieving top-1 accuracies of 91.55%, 71.65%, and 58.13% on CIFAR-10, CIFAR-100, and Tiny-ImageNet, respectively. These low-precision networks are valuable for a range of real-world applications.

Quantization: Two primary methods exist for quantization: Post-Training Quantization (PTQ) and Quantization-Aware Training (QAT). PTQ quantizes a pre-trained model without additional retraining, often resulting in more significant accuracy degradation compared to QAT, which incorporates quantization during the retraining process. The focus of this discussion is on QAT.

In many QAT studies, emphasis is placed on designing the forward and backward propagation processes of the quantizer, the function that transforms continuous weights or activations into discrete values. Early studies such as BNN and XNOR-Net utilize channel-wise scaling during the forward pass, whereas DoReFa-Net introduces a universal scalar applicable to all filters. Recent research has introduced trainable parameters for the quantizer, enhancing control over aspects such as clipping ranges (e.g., PACT, LSQ, APoT, and DSQ) and quantization intervals (e.g., QIL and EWGS). Clipping ranges refer to the bounds within which input values are constrained, and quantization intervals denote the step size between adjacent quantization levels.

Despite advancements, existing QAT methods result in varying levels of accuracy loss and are driven by diverse heuristics, lacking a universally accepted theoretical framework. MQbench reveals that the differences among QAT algorithms are not as significant as originally reported, and no single algorithm achieves optimal performance across all architectures. Additionally, many QAT algorithms are designed for high-bit networks (4 bits or more) and perform poorly with low-bit networks. Therefore, this discussion aims to address this gap by providing a generalized framework that integrates and enhances various QAT methods for both low-bit and high-bit precision settings.

Knowledge Distillation (KD): Knowledge Distillation transfers knowledge from large networks, termed “teacher,” to improve the performance of smaller networks, termed “student.” Hinton et al. first suggested transferring soft logits by minimizing the KL divergence between the teacher's and student's SoftMax outputs and the cross-entropy loss with data labels. Subsequent studies proposed transferring different forms of intermediate representations, such as FSP matrices and attention maps. Despite the success of KD in image classification, its application in model quantization remains limited.

Knowledge Distillation and Quantization: Recent research has applied KD to reduce accuracy loss from quantization, using the low-precision network as the student and the high- or full-precision network as the teacher. Mishra et al. introduced three schemes in Apprentice (AP) to enhance the performance of ternary-precision or 4-bit networks. QKD coordinates quantization and KD through phases including self-studying, co-studying, and tutoring. SPEQ constructs a teacher using the student's parameters and applies stochastic bit precision to the teacher's activations. PTG proposes a four-stage training strategy focusing on sequential optimization of quantized weights and activations, progressive reduction of bit width, and concurrent training of the teacher and the student. CMT-KD promotes collaborative learning among multiple quantized teachers and mutual learning between teachers and the student.

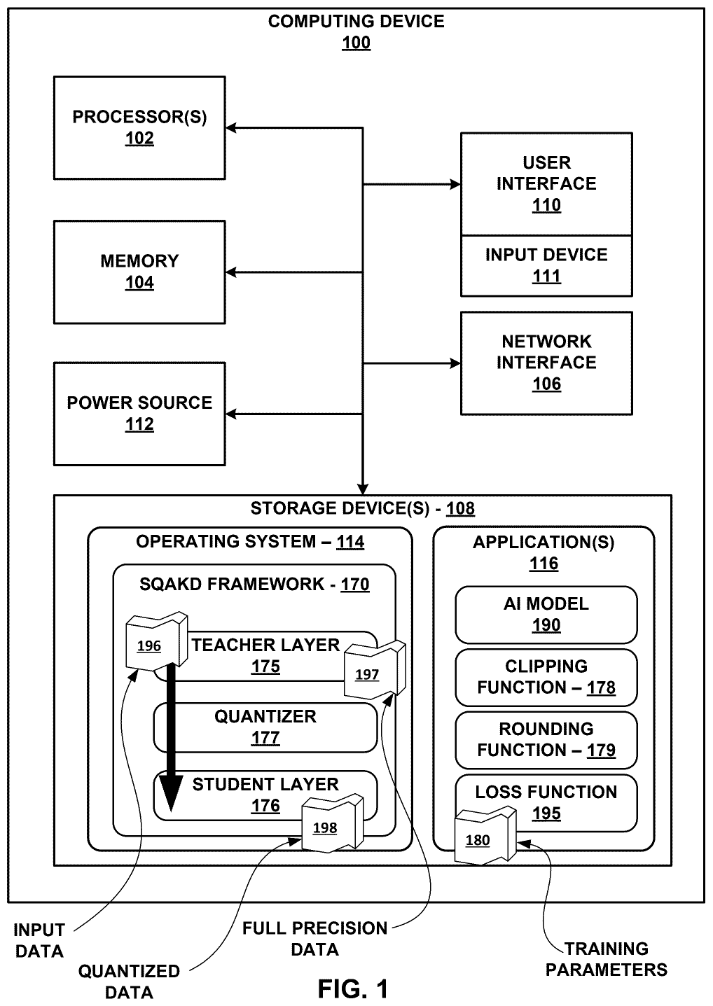

FIG. 1 is a block diagram illustrating further details of one example of computing device, in accordance with aspects of this disclosure. FIG. 1 illustrates only one particular example of computing device 100. Many other example embodiments of computing device 100 may be used in other instances.

Computing device 100 may include processor(s) 102, memory 104, network interface 106, user interface 110, input device 111, storage device(s) 108, and power source 112. Computing device 100 may execute operating system 114 and one or more applications 116 stored on storage device(s) 108.

Processor(s) 102 may execute instructions for controlling and managing the operation of computing device 100. Processor(s) 102 may include one or more central processing units (CPUs), digital signal processors (DSPs), application-specific integrated circuits (ASICs), field-programmable gate arrays (FPGAs), or other types of processing circuitry capable of executing software, firmware, or hardware instructions. Processor(s) 102 may also facilitate interactions between operating system 114 and other components such as memory 104 or network interface 106.

Memory 104 may temporarily store instructions and data for use by processor(s) 102 during execution. Memory 104 may be configured as volatile memory including random access memory (RAM), dynamic RAM (DRAM), static RAM (SRAM), or other suitable forms. In some implementations, memory 104 may act as working memory for applications 116 or operating system 114 while computing device 100 is powered on.

Network interface 106 may be configured to enable communication between computing device 100 and other devices over one or more networks. Network interface 106 may include a network adapter, transceiver, radio, or other interface hardware supporting communications via Ethernet, Wi-Fi, BLUETOOTH®, 3G, 4G, 5G, LTE, USB, or other wired or wireless protocols.

User interface 110 may enable input and output interactions with a user of computing device 100. Input device 111 may include a keyboard, mouse, touchscreen, voice-recognition interface, gesture recognition system, or other input hardware. Output components of user interface 110 may include display screens, speakers, haptic actuators, or combinations thereof.

Power source 112 may provide electrical power to computing device 100. Power source 112 may include a battery composed of nickel-cadmium, lithium-ion, lithium-polymer, or other rechargeable chemistries, or it may draw from an external AC or DC source.

Storage device(s) 108 may provide non-volatile storage for executable code and persistent data. Storage device(s) 108 may include magnetic drives, solid-state drives, flash memory, optical discs, or other storage media. Storage device(s) 108 may store operating system 114, applications 116, and training data and model components utilized by applications 116.

Operating system 114 may include instructions executable by processor(s) 102 to manage computing device 100 and facilitate execution of applications 116. Operating system 114 may interface with application(s) 116 to enable access to hardware resources such as memory 104 or network interface 106.

Operating system 114 may also include SQAKD framework 170. SQAKD framework 170 may be configured to facilitate training of AI model 190 using input data 196. SQAKD framework 170 may include teacher layer 175, student layer 176, and quantizer 177. Input data 196 may be received by teacher layer 175 and student layer 176 of SQAKD framework 170. Teacher layer 175 may generate full precision data 197 from input data 196. Quantizer 177 may apply clipping function 178 and rounding function 179 to full precision data 197 to produce quantized data 198. Student layer 176 may process quantized data 198 to generate an output distribution that approximates the target output of teacher layer 175.

AI model 190 may be trained using outputs from teacher layer 175 and student layer 176. Loss function 195 may receive full precision data 197 and quantized data 198 to compute a training loss indicating a divergence between outputs from teacher layer 175 and student layer 176. Applications 116 may apply loss function 195 to generate training parameters 180. Training parameters 180 may be used by student layer 176 to reduce prediction discrepancy and discretization error relative to teacher layer 175.

Clipping function 178 and rounding function 179 may define quantizer 177. Clipping function 178 may limit values in full precision data 197 to a predefined dynamic range. Rounding function 179 may map clipped full precision values to a discrete representation compatible with low-precision operations in student layer 176. Together, clipping function 178 and rounding function 179 convert full precision data 197 into quantized data 198, which student layer 176 uses during training to improve inference performance under low-precision constraints.

Training parameters 180 may be iteratively generated and stored in storage device(s) 108 or memory 104 and applied to student layer 176 by SQAKD framework 170 to fine-tune weights and bias values. AI model 190 may thus be trained in part by minimizing output discrepancy between student layer 176 operating on quantized data 198 and teacher layer 175 operating on full precision data 197.

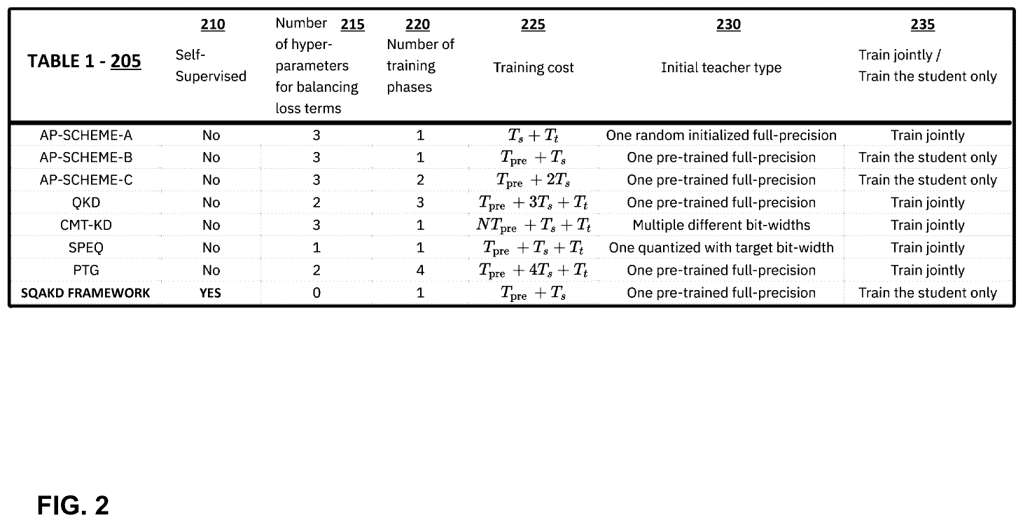

FIG. 2 depicts Table 1 at element 205 as a comparison table that summarizes related works applying knowledge distillation (KD) to quantization-aware training (QAT), in accordance with aspects of the disclosure. Table 1 includes self-supervised column 210, loss balancing column 215, training phases column 220, training cost column 225, teacher type column 230, and training mode column 235.

Self-supervised column 210 indicates whether each technique operates in a self-supervised training configuration. Loss balancing column 215 identifies the number of hyperparameters used to weight different loss terms during training. Training phases column 220 shows the total number of distinct training phases required by each approach. Training cost column 225 expresses the composite training cost using symbolic notation, where Tₛ and Tₜ denote the per-phase training cost of the student and teacher, respectively, and Tₚᵣₑ represents the training cost of a full-precision teacher model prior to QAT. If multiple pre-trained teachers are needed, the training cost may be scaled by a factor N, and the total training duration may include components like Mₛ·Tₛ and Mₜ·Tₜ to account for the number of student and teacher training stages.

Teacher type column 230 specifies the initialization or bit-width condition of the teacher model used during training. Training mode column 235 indicates whether the technique trains both teacher and student jointly or trains the student model only while keeping the teacher fixed.

The first seven rows of comparisons at Table 1, element 205 list prior known approaches to KD in QAT, including AP-SCHEME-A, AP-SCHEME-B, AP-SCHEME-C, QKD, CMT-KD, SPEQ, and PTG. These techniques typically require between one and four training phases, often using multiple hyperparameters for loss term balancing. For example, QKD includes two balancing hyperparameters and three total training phases. CMT-KD requires balancing three hyperparameters across a joint-training configuration with different teacher bit-widths. SPEQ utilizes only one hyperparameter, but still incurs costs for pre-training and full training of both teacher and student. None of the listed prior approaches in Table 1 are self-supervised, as indicated in self-supervised column 210.

Conversely, Table 1, element 205, illustrates that SQAKD framework 170 introduces a more efficient KD strategy. As indicated in self-supervised column 210, SQAKD framework 170 operates in a self-supervised training mode. Loss balancing column 215 shows that SQAKD framework 170 requires zero hyperparameters for loss term balancing. Training phases column 220 and training cost column 225 indicate a simplified two-phase training sequence using Tₚᵣₑ and Tₛ. Teacher type column 230 shows that SQAKD framework 170 uses a single pre-trained full-precision teacher, and training mode column 235 shows that only the student is trained during QAT.

SQAKD framework 170 provides a streamlined and lower-cost approach to quantization-aware training using knowledge distillation. It eliminates hyperparameter balancing, supports self-supervision, and requires fewer training phases compared to earlier methods, while remaining compatible with diverse quantization schemes.

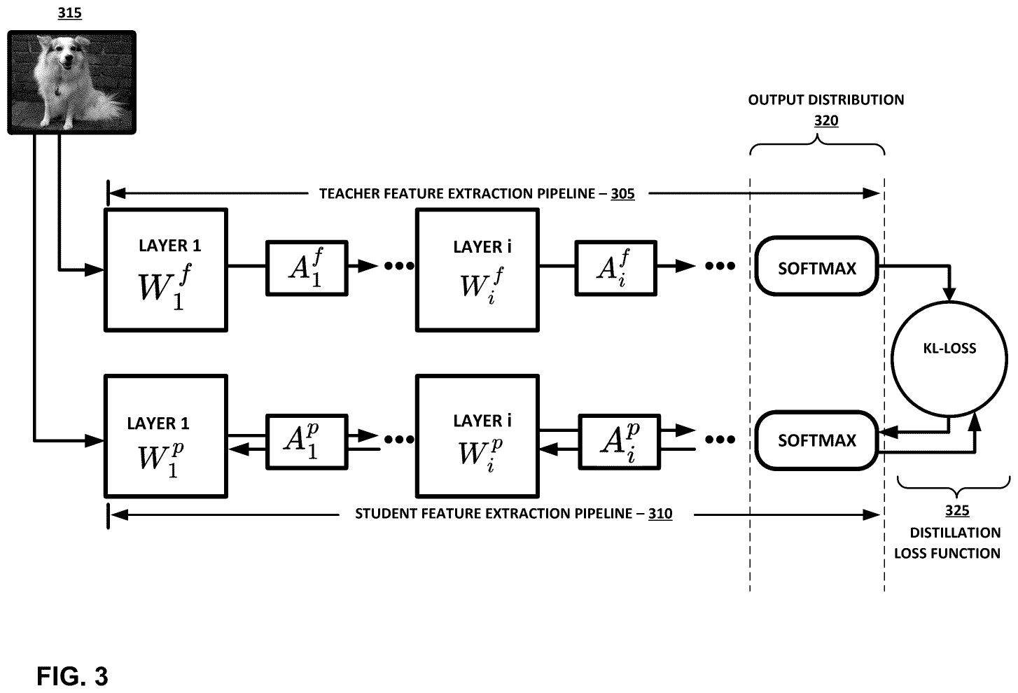

FIG. 3 is a conceptual diagram depicting the workflow of SOAKD framework 170, in accordance with aspects of the disclosure. As shown, the framework includes input image 315, teacher feature extraction pipeline 305, student feature extraction pipeline 310, output distribution 320, and distillation loss function 325. Input image 315 receives an image (e.g., a dog photograph) and feeds it concurrently into teacher feature extraction pipeline 305 and student feature extraction pipeline 310.

Teacher feature extraction pipeline 305 includes multiple sequential layers, such as layer 1

$$( {W}_{1}^{f} )$$

and layer i

$$( {W}_{i}^{f} ) ,$$

which respectively output activation outputs

$$( {A}_{1}^{f} ) and ( {A}_{i}^{f} ) .$$

Similarly, student feature extraction pipeline 310 includes corresponding layers, such as layer 1

$$( {W}_{1}^{p} )$$

and layer i

$$( {W}_{i}^{p} ) ,$$

which produce activation outputs

$$( {A}_{1}^{p} ) and ( {A}_{i}^{p} ) .$$

Each set of activation outputs feeds into corresponding SoftMax layers within output distribution 320, which generates probabilistic outputs.

The outputs from the SoftMax layers are compared using a Kullback Leibler divergence-based loss in distillation loss function 325, enabling transfer learning by aligning the outputs of teacher feature extraction pipeline 305 and student feature extraction pipeline 310.

In the context of Knowledge Distillation (KD) for Quantization-Aware Training (QAT), a teacher is a pre-trained full-precision network that serves as a reference model, providing a benchmark for performance. The student is a low-bit network, which is a quantized version of the teacher's architecture with reduced precision. Guiding a low-bit student involves using the teacher's outputs to train the student network, helping it to approximate the teacher's performance despite its reduced capacity. This process involves aligning the student's predictions with those of the teacher, thereby transferring knowledge and optimizing the student network to maintain accuracy while operating with lower precision. This approach aims to leverage the teacher's extensive knowledge to improve the efficiency and performance of the quantized student network.

FIG. 3 illustrates this mechanism, where teacher feature extraction pipeline 305 and student feature extraction pipeline 310 each process the same input image 315 to generate activation outputs across multiple layers, ultimately producing output distributions that are compared via KL-Loss.

As shown in FIG. 3, input image 315 is processed by both teacher feature extraction pipeline 305 and student feature extraction pipeline 310, each comprising a sequence of layers (e.g.,

$${W}_{1}^{f} to {iW}_{i}^{f} and {W}_{1}^{p} and layer {iW}_{i}^{p} ,$$

respectively, that produce activation outputs

$${A}_{1}^{f} through {A}_{i}^{f} and {A}_{1}^{p} through {A}_{i}^{p} .$$

These outputs feed into corresponding SoftMax layers within output distribution 320, which generates probabilistic outputs. Both sets of outputs are input into distillation loss function 325, where they are compared using a KL-Loss function to guide the training of student feature extraction pipeline 310.

### Methodology:

QAT as Constrained Optimization: In one implementation, SQAKD framework 170 may unify various quantization techniques within a single constrained optimization process. To establish a generalized theoretical framework, framework 170 may first unify the forward and backward dynamics of various quantizers and formulate Quantization-Aware Training (QAT) as an optimization problem. This formulation enables SQAKD framework 170 to model QAT as a unified constrained learning process, making it compatible with a wide range of quantization strategies while maintaining mathematical consistency.

### Forward Propagation:

Define Quant (⋅) as a uniform quantizer that converts a full-precision input x to a quantized output x_{q}=Quant(x). The input x may represent activations or weights within the network. Initially, the quantizer Quant (⋅) applies a clipping function Clip(⋅), which normalizes and restricts the full-precision input x to a limited range, producing a full-precision latent representation x_{c}, according to Equation 1, set forth below as follows:

$${x}_{c} = Clip ( x , {\{ {p}_{i} \}}_{i = 1}^{i = {K}_{c}} , v , m ) ,$$

where, v and m represent the lower and upper bounds of the range, respectively,

$${\{ {p}_{i} \}}_{i = 1}^{i = {K}_{c}}$$

denotes the set of trainable parameters needed for quantization, and Ke represents the number of parameters.

Different quantizers utilize different schemes for Clip(⋅). For instance, in PACT, the lower bound v is set to 0 and the upper bound m is a trainable parameter optimized during training. The quantizer, in this case, requires only one parameter. That parameter is {p₁|p₁=m, K_{c}=1}, with the clipping function described as follows:

$${x}_{c} = Clip ( x , \{ {p}_{1} \vert {p}_{1} = m \} , 0 , m ) = 0.5 ( \vert x \vert - \vert x - m \vert + m ) .$$

In EWGS, v and m are set to 0 and 1, respectively, and each quantized layer uses separate parameters (i.e., p₁ and p₂) for quantization intervals as follows:

$${x}_{c} = Clip ( x , \{ {p}_{1} , {p}_{2} \} , 0 , 1 ) = clip ( \frac{x - {p}_{1}}{{p}_{1} - {p}_{2}} , 0 , 1 ) .$$

Subsequently, the quantizer Quant(⋅) converts the clipped value x_{c} to a discrete quantization point x_{q} using the function R(⋅), which includes the rounding function according to Equation 2, set forth below, as follows:

$${x}_{q} = R ( {x}_{c} , b , {\{ {q}_{i} \}}_{i = 1}^{i = {K}_{r}} ) ,$$

where b represents the bit width, and

$${\{ {q}_{i} \}}_{i = 1}^{i = {K}_{r}}$$

denotes the set of trainable parameters. Note that

$${\{ {q}_{i} \}}_{i = 1}^{i = {K}_{r}}$$

may not be necessary for some quantizers. For example, in EWGS, if activations are the input,

$${x}_{q} = R ( {x}_{c} , b ) = \frac{round ( ( {2}^{b} - 1 ) \cdot {x}_{c} )}{{2}^{b} - 1} ;$$

and if weights are the input,

$${x}_{q} = R ( {x}_{c} , b ) = 2 ( \frac{round ( ( {2}^{b} - 1 ) \cdot {x}_{c} )}{{2}^{b} - 1} - 0.5 ) .$$

In certain quantizers, such as PACT and LSQ, the trainable parameters in the function R(⋅) align with those in the clipping function Clip(⋅), i.e.,

$${\{ {q}_{i} \vert {q}_{i} = {p}_{i} \}}_{i = 1}^{i = {K}_{r}} .$$

Thus, where the quantizer Quant(⋅) is described as

$${x}_{q} = Quant ( x , α , b , v , m ) ,$$

where α represents a shorthand for the set of all parameters in the functions R(⋅) and Clip(⋅):

$$α = \{ {\{ {p}_{i} \}}_{i = 1}^{i = {K}_{c}} , {\{ {q}_{i} \}}_{i = 1}^{i = {K}_{r}} \} .$$

Backward Propagation: Directly training a quantized network using back-propagation presents a challenge because the quantizer Q(⋅) is non-differentiable. This difficulty arises due to the rounding function in Equation 2, which results in near-zero derivatives almost everywhere. To address this issue, many quantization-aware training (QAT) approaches use the Straight-Through Estimator (STE) to approximate the gradients:

$$\frac{\partial L}{\partial {x}_{c}} = \frac{\partial L}{\partial {x}_{q}} .$$

Instead of utilizing the conventional STE for backpropagation, a formula is described to integrate the discretization error (x_{c}−x_{q}), which represents the deviation between full precision and its quantized weights/activations according to Equation 3, set forth below, as follows

$$\frac{\partial L}{\partial {x}_{c}} = \frac{\partial L}{\partial {x}_{q}} + μ \cdot ( {x}_{c} - {x}_{q} ) ,$$

where μ is a non-negative value. Setting μ to zero represents the STE, whereas an Error Weight Gradient Scheme (EWGS) is achieved when μ is the product of δ (a non-negative value),

$$sign ( \frac{\partial L}{\partial {x}_{q}} ) , and \frac{\partial L}{\partial {x}_{q}} .$$

Notably, μ may also be updated using other strategies, such as a Curriculum Learning driven approach.

Optimization Objective: Quantization-aware training (QAT) is framed as an optimization problem that minimizes both the discretization error and the discrepancy between model predictions and true labels. The objective is to achieve precise quantization without compromising predictive accuracy. The optimization objective is defined according to Equation 4, set forth below, as follows:

$${min}_{{W}_{f} , {α}_{W} , {α}_{A}} L ( {W}_{f} )$$

$$s . t . {W}_{q} = {Quant}_{W} ( {W}_{f} , {α}_{W} , {b}_{W} , {v}_{W} , {m}_{W} ) ,$$

$${A}_{q} = {Quant}_{A} ( {A}_{f} , {α}_{A} , {b}_{A} , {v}_{A} , {m}_{A} ) ,$$

where Quant_{W}(⋅) and Quant_{A}(⋅) are the quantizers for weights and activations, respectively, and where W_{f}/A_{f} denote the model's full-precision and quantized weights/activations.

The loss function L(⋅) may be the cross-entropy loss with labels or other loss functions, such as distillation loss.

In such a way, SQAKD framework 170 utilizes generalized diverse quantizers, incorporating both forward and backward propagations into a unified formulation of an optimization problem. The generalized diverse quantizers and formulation enable SQAKD framework 170 to integrate various state-of-the-art quantizers and to integrate various state-of-the-art quantizers and improve model performance.

Analysis of KD in QAT: Use of Knowledge Distillation (KD) and its effectiveness in addressing quantization-aware training (QAT) was analyzed. To apply KD in QAT, a pre-trained full-precision network serves as the teacher, guiding a low-bit student with the same architecture.

Next, the training loss described according to Equation 4 above is defined as a linear combination of the cross-entropy loss with labels and the distillation loss between the teacher's and student's output distributions, controlled by a hyperparameter a, according to Equation 5, set forth below, as follows:

$$L = ( 1 - λ ) {L}_{CE} + λ {L}_{Distill} .$$

The distillation loss L_{Distill} may be a single term, such as the KL divergence loss, or multiple terms, such as intermediate-representation-based contrastive losses.

The hypothesis is that existing KD methods, while effective in standard training scenarios, may not perform adequately in QAT. This is because quantized networks have lower representational capacity compared to their full-precision counterparts, making it challenging to optimize multiple loss terms effectively. Additionally, quantization introduces noise to network weights or activations due to discretization, which can degrade the performance of KD methods that rely on fine-grained information or specific output matching.

To validate this hypothesis, an evaluation of 11 KD methods was performed in the context of quantization, as described in greater detail below. This evaluation represents the first attempt to provide a comprehensive assessment of KD performance in addressing QAT issues.

Necessity of both cross-entropy loss and distillation loss: To address the issue of KD methods underperforming in QAT, the significance of two loss components is analyzed: the cross-entropy loss (referred to as CE-Loss) with labels and the KL divergence loss (referred to as KL-Loss) between the teacher's and student's penultimate outputs before logits. The term “logits” refers to the raw, unnormalized output values produced by a neural network before they are passed through an activation function, such as a SoftMax function. These logits represent the network's confidence scores for each class in classification tasks, but they are not probabilities themselves. They are used to calculate loss functions, such as the cross-entropy loss, which helps in optimizing the network during training. Logits are used by the distillation process, where the logits enable the alignment of the student's outputs with the teacher's outputs, facilitating the transfer of knowledge from the teacher network to the student network.

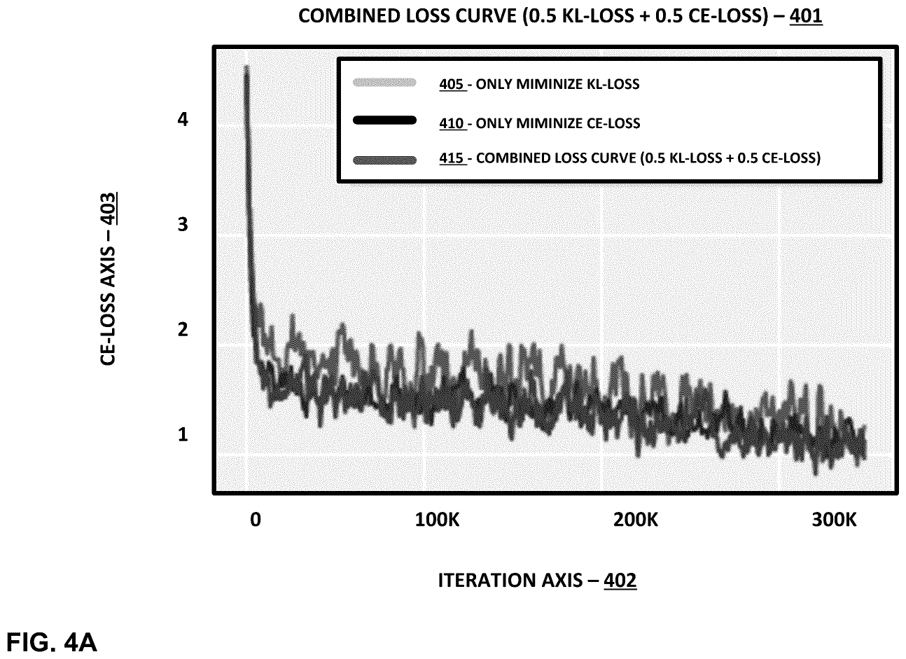

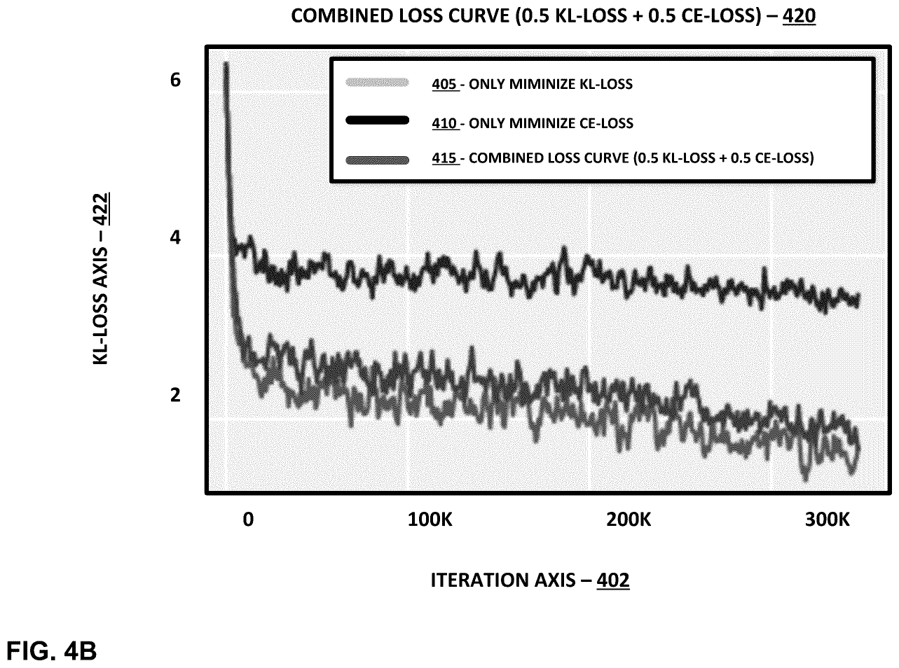

FIGS. 4A and 4B illustrate the evolution of CE-Loss and KL-Loss during training of a 1-bit VGG-13 network on CIFAR-100, in accordance with aspects of the disclosure. In FIG. 4A, CE-Loss axis 403 is plotted across iteration axis 402. In FIG. 4B, KL-Loss axis 422 is likewise plotted across iteration axis 402. In both figures, combined loss curve 401 represents the composite optimization objective used for training.

Three training configurations are represented. Only minimize KL-loss 405 corresponds to setting λ=1. Only minimize CE-loss 410 corresponds to setting λ=0. Combined loss curve 415 reflects joint minimization of CE-loss and KL-loss with equal weighting (λ=0.5).

As shown in FIG. 4A, minimizing KL-loss 405 alone effectively reduces CE-Loss over time, indicating that the low-bit network can align well with the ground-truth labels without explicit label supervision. In contrast, FIG. 4B shows that only minimize CE-loss 410 and combined loss curve 415 do not achieve comparable KL-Loss minimization, suggesting that CE-loss may interfere with KL-loss optimization. Minimizing KL-loss alone yields more effective gradient updates and eliminates the need for a balancing hyperparameter.

Optimization via Self-Supervised KD: By eliminating the CE-Loss and retaining only the KL-Loss in SQAKD framework 170, the optimization objective in Equation 4 above is defined according to Equation 6, set forth below, as follows:

$${min}_{{W}_{f}^{S} , {α}_{W} , {α}_{A}} KL ( S ( {h}^{T} / ρ ) ‖ ( S ( {h}^{S} / ρ ) )$$

$$s . t . {W}_{q}^{S} = {Quant}_{W} ( {W}_{f}^{S} , {α}_{W} , {b}_{W} , {v}_{W} , {m}_{W} )$$

$${A}_{q}^{S} = {Quant}_{A} ( {A}_{f}^{S} , {α}_{A} , {b}_{A} , {v}_{A} , {m}_{A} ) ,$$

where the term ρ is the temperature parameter that softens the distribution to utilize dark knowledge, where the term Y represents the ground-truth labels, and where the terms h^{T} and h^{S} are the penultimate layer outputs of the teacher and student, respectively. Quant_{W}(⋅) and Quant_{A}(⋅) denote the quantization functions for the student's weights and activations, while the terms

$${W}_{f}^{S} / {A}_{f}^{S} and {W}_{q}^{S} / {A}_{q}^{S}$$

refer to the student's full-precision weights/activations and quantized weights/activations.

During training, the teacher's weights remain fixed and are only used for forward propagation. In the forward pass, the student's parameters are quantized, but the corresponding full-precision values are maintained internally. In the backward pass, gradients are applied to the student's preserved full-precision values. Upon convergence, the student retains its full-precision weights and the parameters used in the quantizer. The student's quantized weights are derived by applying the quantizer to the full-precision weights.

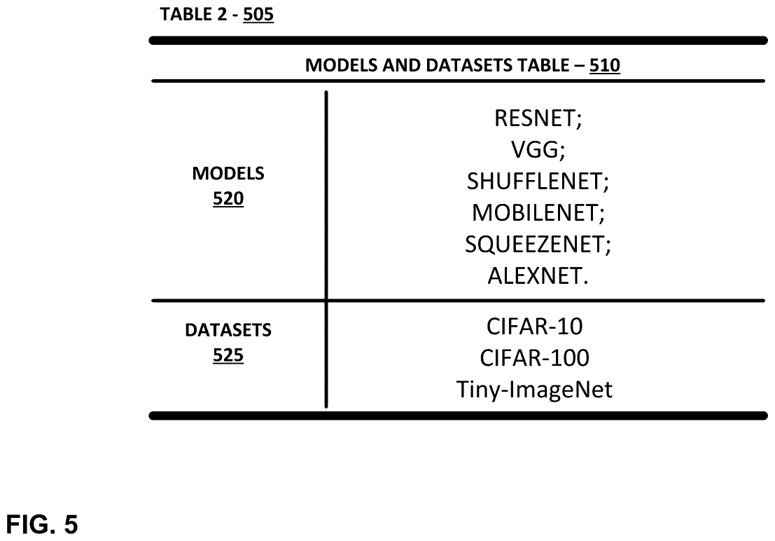

FIG. 5 depicts Table 2 at element 505 including models and datasets table 510, which provides a summary of models and datasets, in accordance with aspects of the disclosure. Models and datasets table 510 includes models 520 and datasets 525. Models 520 includes ResNet, VGG, ShuffleNet, MobileNet, SqueezeNet, and AlexNet, which were utilized for the evaluation. Datasets 525 includes CIFAR-10, CIFAR-100, and Tiny-ImageNet, which were used in combination with models 520 for experimental evaluation.

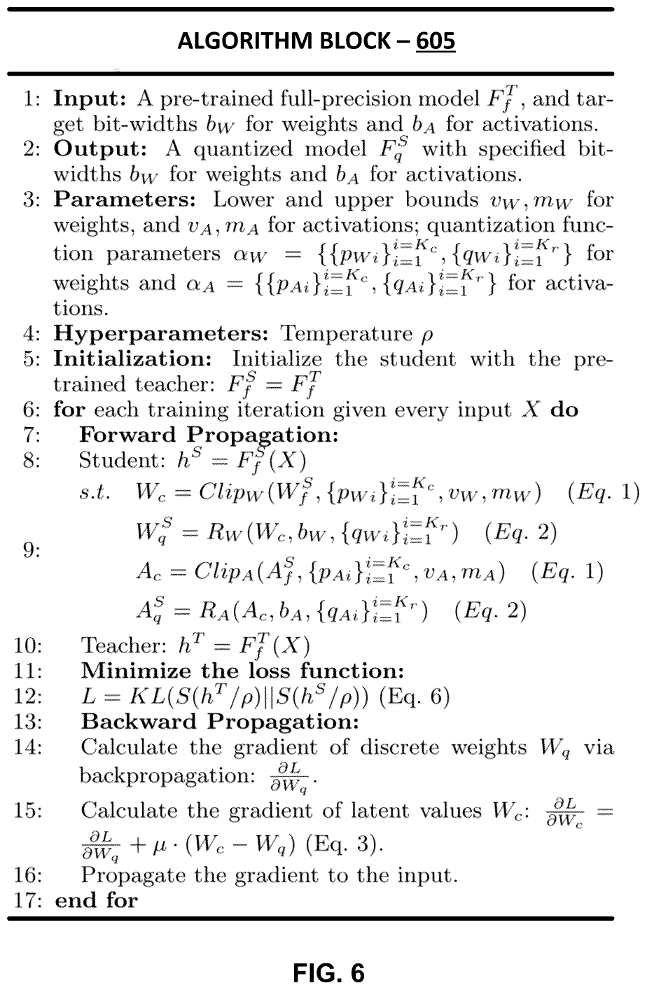

FIG. 6 depicts algorithm block 605 providing example pseudocode for self-supervised quantization-aware knowledge distillation, in accordance with aspects of the disclosure. The overall procedure of SQAKD framework 170 utilized for the evaluation is detailed in algorithm block 605. The pseudocode begins by taking as input a pre-trained full-precision mode

$${F}_{F}^{T} ,$$

along with target bit-widths b_{W} for weights and b_{A} for activations. The output is a quantized model

$${F}_{Q}^{S}$$

with the specified bit-widths b_{W} and b_{A}.

Algorithm block 605 defines parameters including lower and upper bounds v_{W}, m_{W} for weights and v_{A}, m_{A} for activations. Quantization function parameters α_{W} are defined as sets of learnable parameters for weight quantization functions and α_{A} for activation quantization functions. Temperature ρ is set as a hyperparameter for the distillation loss.

Initialization is performed by setting the student model

$${F}_{F}^{S}$$

equal to the teacher model

$${F}_{F}^{T} .$$

For each training iteration, given an input X, forward propagation is executed by passing X through the student model to compute

$${h}^{S} = {F}_{F}^{S} ( X ) .$$

Intermediate latent weight values W_{c} are computed using a clipping function over the student weights

$${W}_{F}^{S} ,$$

the learnable quantization parameters {p_{Wi}}, {q_{Wi}}, and the clipping bounds v_{W}, m_{W}. The quantized weights

$${W}_{q}^{S}$$

are derived using a rounding function over W_{c} and the weight quantization parameters. Activations are similarly quantized using a two-step process involving clipping and rounding operations with respective activation parameters {p_{Ai}}, {q_{Ai}} and bounds v_{A},m_{A}.

The teacher's forward pass outputs

$${h}^{T} = {F}_{F}^{T} ( X ) .$$

The knowledge distillation loss function is then computed as the Kullback-Leibler divergence between the SoftMax-normalized teacher and student outputs, scaled by temperature ρ.

During backward propagation, gradients of the quantized weights W_{q} and latent weights W_{c} are calculated with respect to the loss. The update for W_{c} includes a straight-through estimator formulation combining gradients with a scaling term μ. The resulting gradients are propagated to the input.

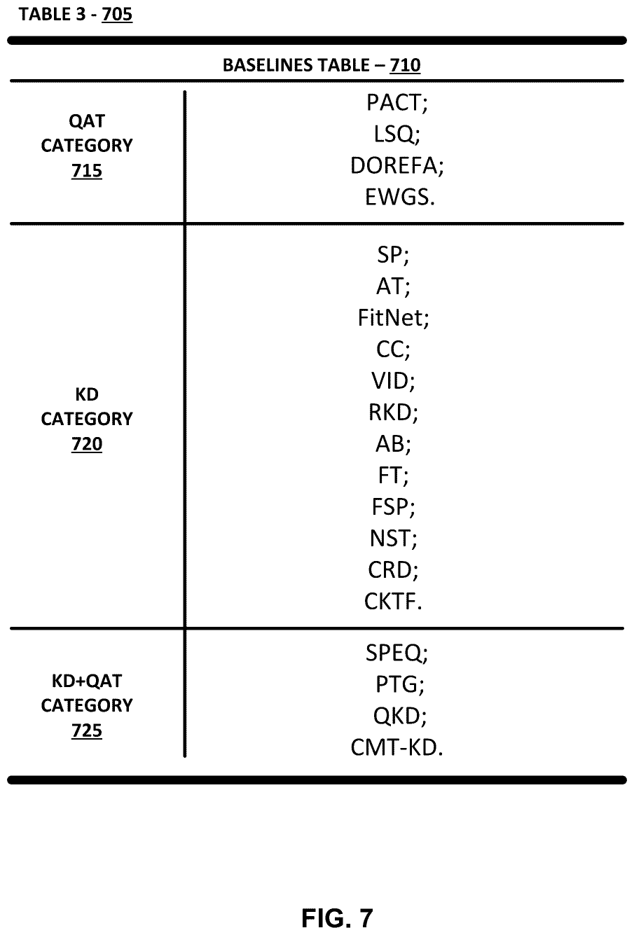

FIG. 7 depicts baselines table 710 at element 705 providing a summary of baselines, in accordance with aspects of the disclosure. Baselines table 710 includes QAT category 715 with PACT; LSQ; DoReFa; and EWGS. Baselines table 710 further includes KD category 720 with SP; AT; FitNet; CC; VID; RKD; AB; FT; FSP; NST; CRD; and CKTF. Baselines table 710 also includes KD+QAT category 725 with SPEQ; PTG; QKD; and CMT-KD.

Evaluation: An extensive evaluation was conducted across various models and datasets, as outlined in table 2 at element 505 as set forth by FIG. 5. SQAKD framework 170 was compared with three categories of state-of-the-art methods: QAT category 715, KD category 720, and KD+QAT category 725, as indicated in baselines table 710.

SQAKD framework 170 was implemented using PyTorch version 1.10.0 and Python version 3.9.7. Four Nvidia RTX 2080 GPUs were utilized for model training, and inference experiments were carried out on Jetson Nano using NVIDIA TensorRT.

### Improvements on SOTA QAT Methods:

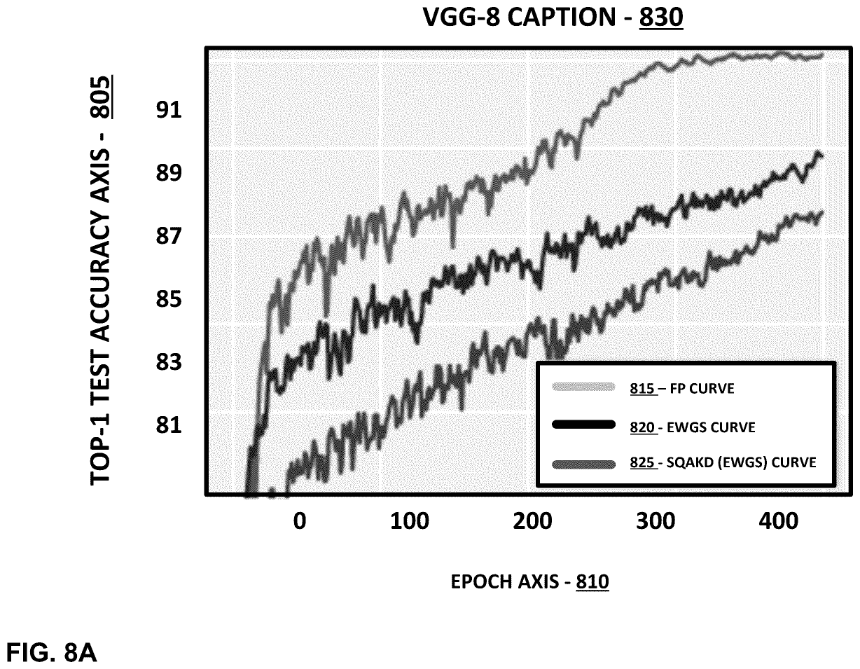

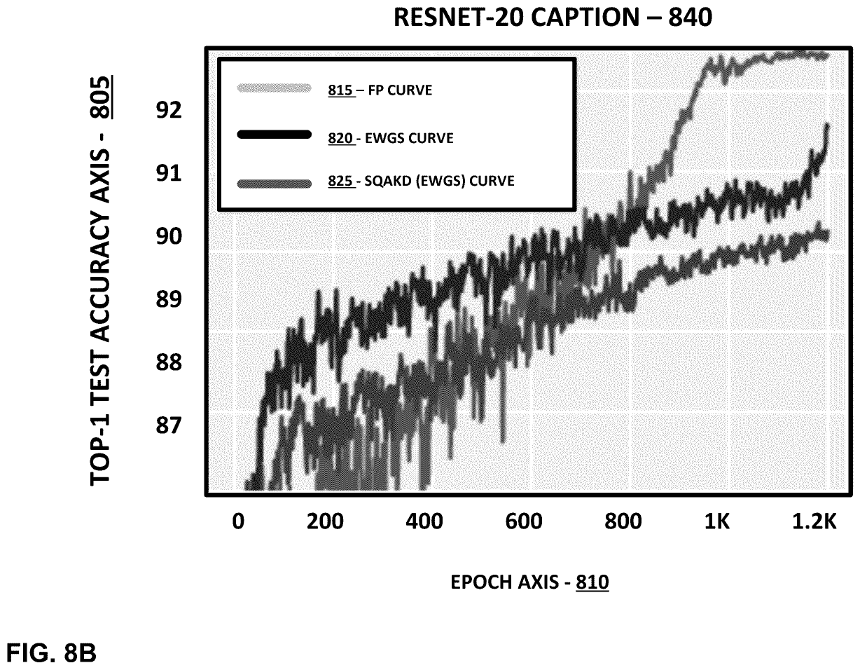

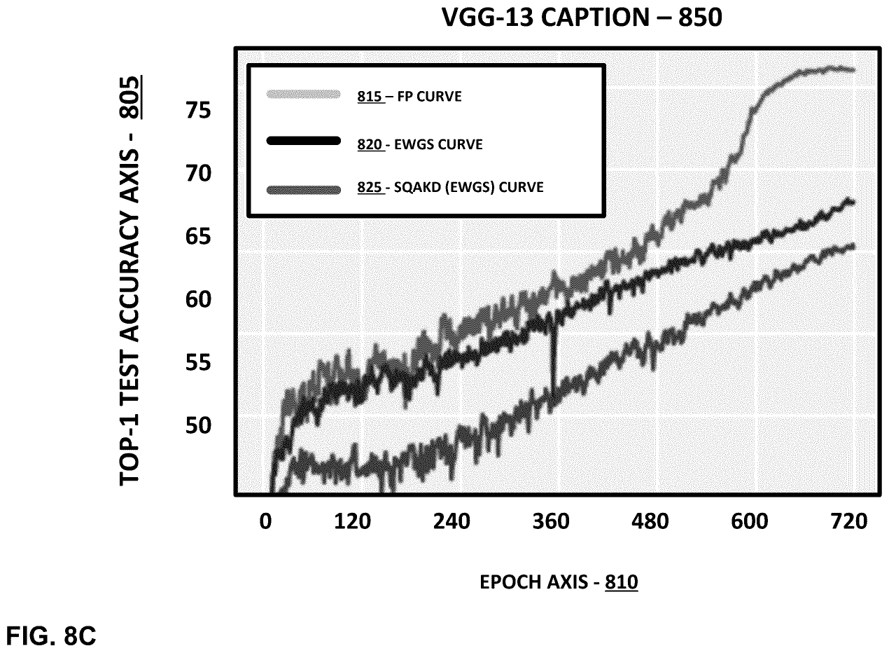

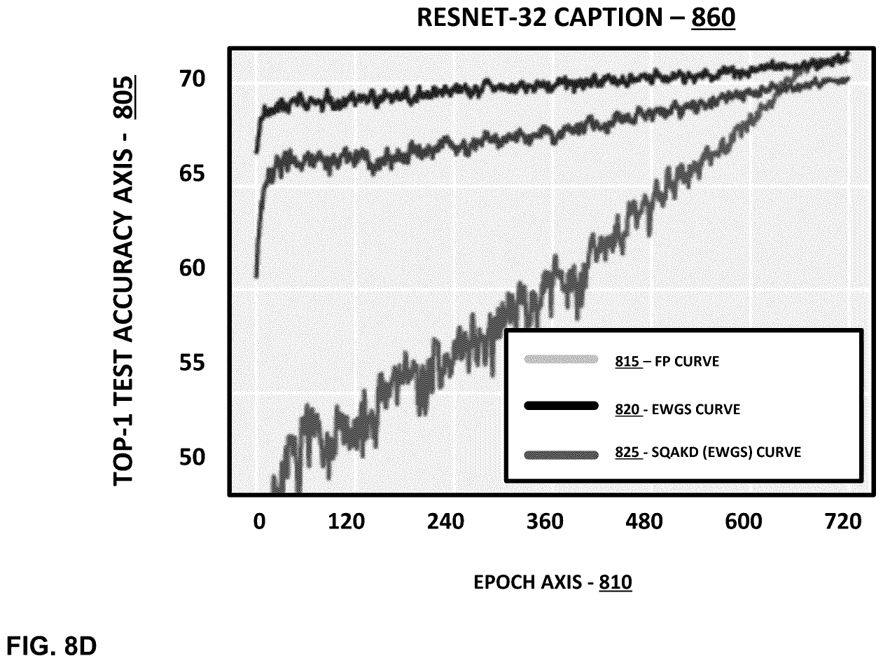

FIGS. 8A, 8B, 8C, and 8D illustrate the evolution of top-1 test accuracy of Full-Precision (FP) and quantized models using EWGS and SQAKD integrating EWGS during training, in accordance with aspects of the disclosure. In FIG. 8A, top-1 test accuracy axis 805 is plotted against epoch axis 810, with FP curve 815, EWGS curve 820, and SQAKD (EWGS) curve 825 depicted. VGG-8 caption 830 identifies the model configuration W1A1 on the CIFAR-10 dataset. In FIG. 8B, top-1 test accuracy axis 805 is plotted against epoch axis 810, with FP curve 815, EWGS curve 820, and SQAKD (EWGS) curve 825 shown. RESNET-20 caption 840 denotes the model configuration W2A2 on the CIFAR-10 dataset. In FIG. 8C, top-1 test accuracy axis 805 is plotted against epoch axis 810, with FP curve 815, EWGS curve 820, and SQAKD (EWGS) curve 825 represented. VGG-13 caption 850 denotes the model configuration W1A1 on the CIFAR-100 dataset. In FIG. 8D, top-1 test accuracy axis 805 is plotted against epoch axis 810, with FP curve 815, EWGS curve 820, and SQAKD (EWGS) curve 825 illustrated. RESNET-32 caption 860 denotes the model configuration W4A4 on the CIFAR-100 dataset.

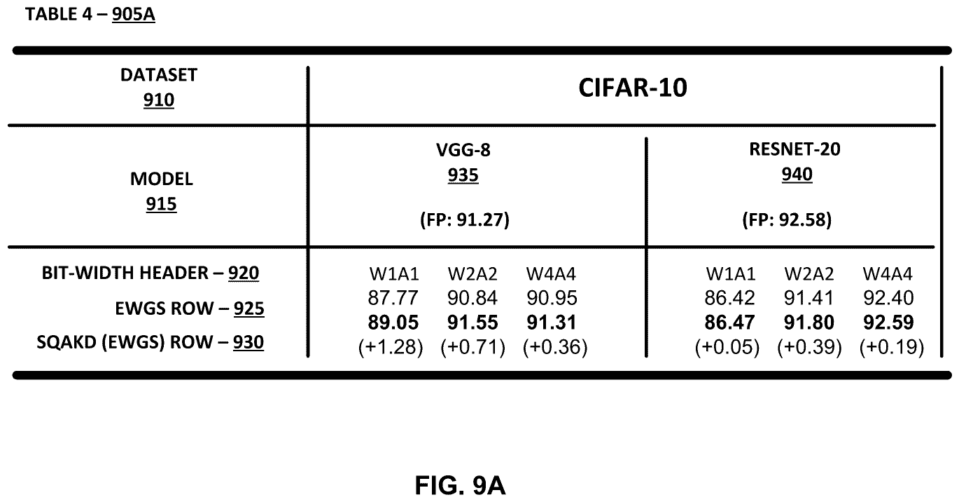

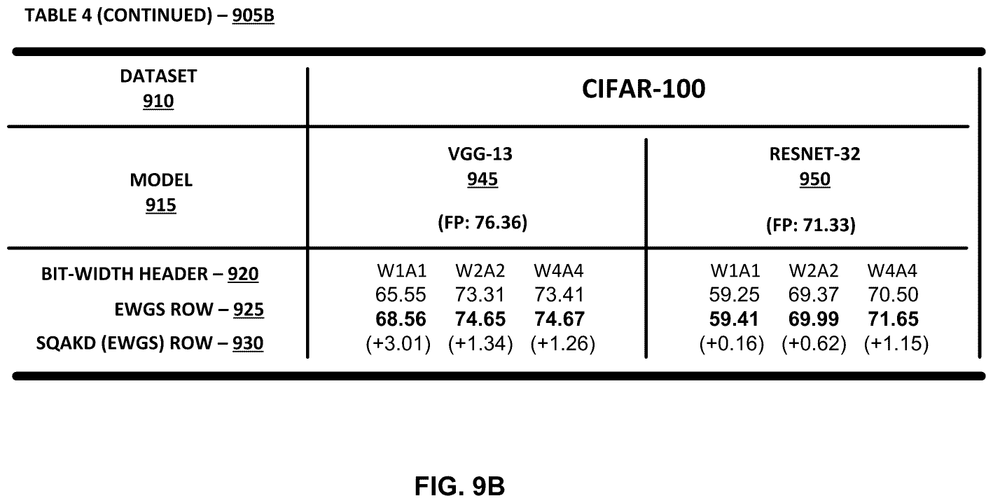

FIG. 9A depicts Table 4 at element 905A providing a summary of top-1 test accuracy (%) on CIFAR-10, in accordance with aspects of the disclosure. Dataset 910 specifies CIFAR-10, and model 915 specifies the architectures evaluated. VGG-8 935 and ResNet-20 940 are shown as columns, with corresponding full-precision (FP) baseline accuracies included in parentheses. Bit-width header 920 indicates the quantization schemes applied, including W1A1, W2A2, and W4A4. EWGS row 925 presents accuracy values obtained from the standalone EWGS method. SQAKD (EWGS) row 930 presents accuracy values obtained from SQAKD framework 170 integrating EWGS, with the improvement relative to EWGS shown in parentheses.

FIG. 9B depicts Table 4 (continued) at element 905B providing a summary of top-1 test accuracy (%) on CIFAR-100, in accordance with aspects of the disclosure. Dataset 910 specifies CIFAR-100, and model 915 specifies the architectures evaluated. VGG-13 945 and ResNet-32 950 are shown as columns, with corresponding FP baseline accuracies included in parentheses. Bit-width header 920 indicates the quantization schemes applied, including W1A1, W2A2, and W4A4. EWGS row 925 presents accuracy values obtained from the standalone EWGS method. SQAKD (EWGS) row 930 presents accuracy values obtained from SQAKD framework 170 integrating EWGS, with the improvement relative to EWGS shown in parentheses.

SQAKD framework 170 is shown to significantly enhance the accuracy of EWGS across all bit quantization scenarios. Specifically, on CIFAR-10, SQAKD framework 170 improves EWGS by 0.36% to 1.28% on VGG-8 935 and by 0.05% to 0.39% on ResNet-20 940. On CIFAR-100, the improvement ranges from 1.26% to 3.01% on VGG-13 945 and from 0.16% to 1.15% on ResNet-32 950.

Notably, SQAKD framework 170 results in quantized models with higher accuracy compared to full-precision models. For instance, on ResNet-32 950 with CIFAR-100, a 4-bit model trained with SQAKD framework 170 surpasses the full-precision model by 0.32%. These compact and accurate models are advantageous for real-world applications, especially for edge deployment. In contrast, standalone EWGS results in accuracy drops ranging from 0.18% to 6.16% across all quantization scenarios.

With reference again to FIGS. 4A 4B, the top-1 test accuracy evolution is shown for full-precision and quantized models during each epoch of training on CIFAR-10 and CIFAR-100. Compared to standalone EWGS, SQAKD framework 170 significantly accelerates the convergence speed of 1-bit VGG-8 935 and 2-bit ResNet-20 940 on CIFAR-10, as well as 1-bit VGG-13 945 and 4-bit ResNet-32 950 on CIFAR-100. These results confirm that SQAKD framework 170 enhances EWGS in both convergence speed and final accuracy.

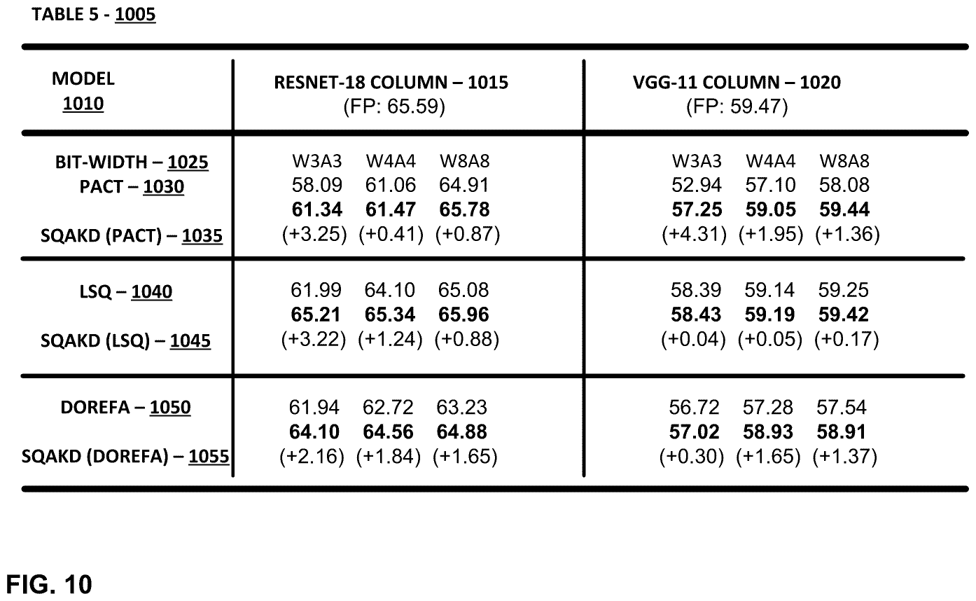

FIG. 10 depicts Table 5 1005 providing a summary of Top-1 test accuracy (%) of ResNet-18 column 1015 and VGG-11 column 1020 on Tiny-ImageNet, in accordance with aspects of the disclosure. Model 1010 specifies ResNet-18 column 1015 with a full-precision baseline of 65.59% and VGG-11 column 1020 with a full-precision baseline of 59.47%.

Results on Tiny-ImageNet, as shown in Table 5 1005 set forth by FIG. 10, indicate that SQAKD framework 170 consistently improves the Top-1 accuracy of various QAT methods, including PACT 1030, LSQ 1040, and DoReFa 1050, as listed under bit-width 1025. Each QAT method is further compared against its enhanced counterpart SQAKD (PACT) 1035, SQAKD (LSQ) 1045, and SQAKD (DoReFa) 1055, respectively, for W3A3, W4A4, and W8A8 quantization settings.

For example, on 3-bit ResNet-18 column 1015, SQAKD framework 170 improves PACT 1030 from 58.09% to 61.34%, a gain of 3.25%. SQAKD framework 170 achieves more significant improvements in lower-bit quantization compared to higher-bit configurations. On ResNet-18 column 1015, the Top-1 accuracy improvements using LSQ 1040 increase as bit-width decreases: from 0.88% at W8A8, to 1.24% at W4A4, and up to 3.22% at W3A3. Similar accuracy improvements are observed in DoReFa 1050 with ResNet-18 column 1015 and PACT 1030 with VGG-11 column 1020. This behavior is expected, as lower-bit quantization induces higher information loss, and SQAKD framework 170 mitigates this degradation effectively.

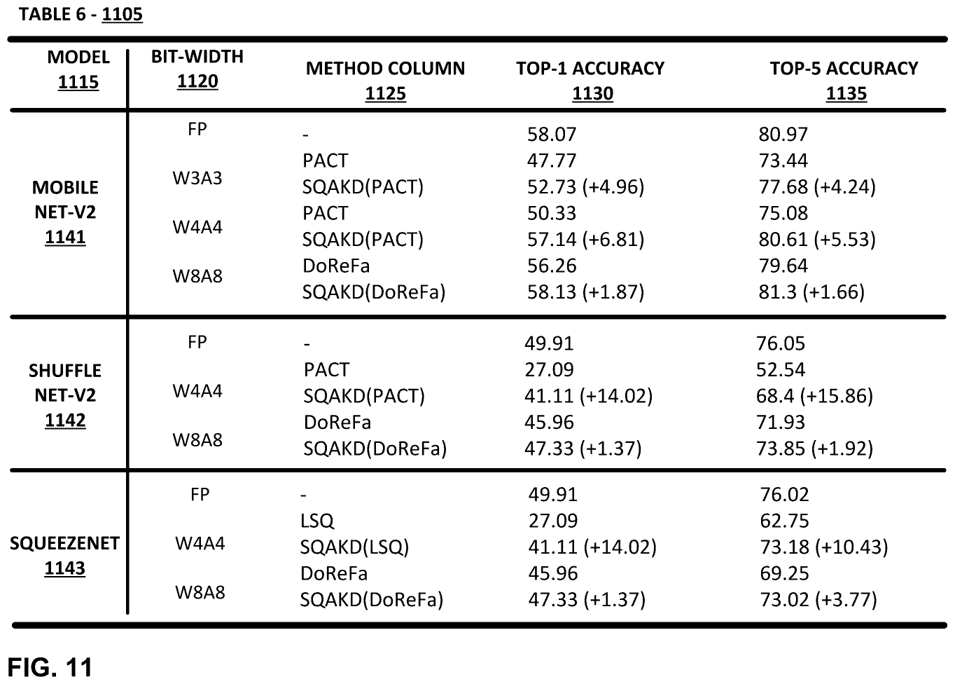

FIG. 11 depicts Table 6 at element 1105 providing a summary of Top-1 accuracy and Top-5 accuracy values for MobileNet-V2 1141, ShuffleNet-V2 1142, and SqueezeNet 1143 on Tiny-ImageNet, in accordance with aspects of the disclosure. Column headers include model 1115, bit-width 1120, method column 1125, Top-1 accuracy 1130, and Top-5 accuracy 1135.

SQAKD framework 170 quantizes MobileNet-V2 1141 using multiple configurations: W3A3, W4A4, and W8A8, as shown in method column 1125. Compared to baseline methods such as PACT and DoReFa, SQAKD(PACT) and SQAKD(DoReFa) result in improved accuracy metrics. For W4A4 quantization, SQAKD(PACT) yields a Top-1 accuracy of 57.14 (+6.81) and a Top-5 accuracy of 80.61 (+5.53) relative to the PACT baseline. With W8A8, SQAKD(DoReFa) further improves Top-1 accuracy to 58.13 (+1.87) and Top-5 accuracy to 81.3 (+1.66), exceeding the full-precision baseline.

For ShuffleNet-V2 1142, quantization is shown for W4A4 and W8A8 settings. SQAKD(PACT) applied at W4A4 achieves Top-1 accuracy of 41.11 (+14.02) and Top-5 accuracy of 68.4 (+15.86), relative to the PACT baseline. SQAKD(DoReFa) at W8A8 achieves Top-1 accuracy of 47.33 (+1.37) and Top-5 accuracy of 73.85 (+1.92), again improving upon DoReFa.

SqueezeNet 1143 is also quantized under W4A4 and W8A8 configurations. SQAKD(LSQ) improves upon LSQ by 12.03% and 10.43% in Top-1 accuracy and Top-5 accuracy respectively. Specifically, SQAKD(LSQ) achieves a Top-1 accuracy of 47.40 and Top-5 accuracy of 73.18. SQAKD(DoReFa) achieves 46.62 in Top-1 accuracy and 73.02 in Top-5 accuracy, outperforming DoReFa by 3.96% and 3.77%, respectively.

The distillation process in SQAKD framework 170 mitigates quantization-induced degradation by leveraging knowledge transfer from the teacher model to guide low-bit weight updates. SQAKD framework 170 effectively supports quantization of already compact architectures such as MobileNet-V2 1141, ShuffleNet-V2 1142, and SqueezeNet 1143, with demonstrated performance improvements shown in Table 6 depicted in FIG. 11.

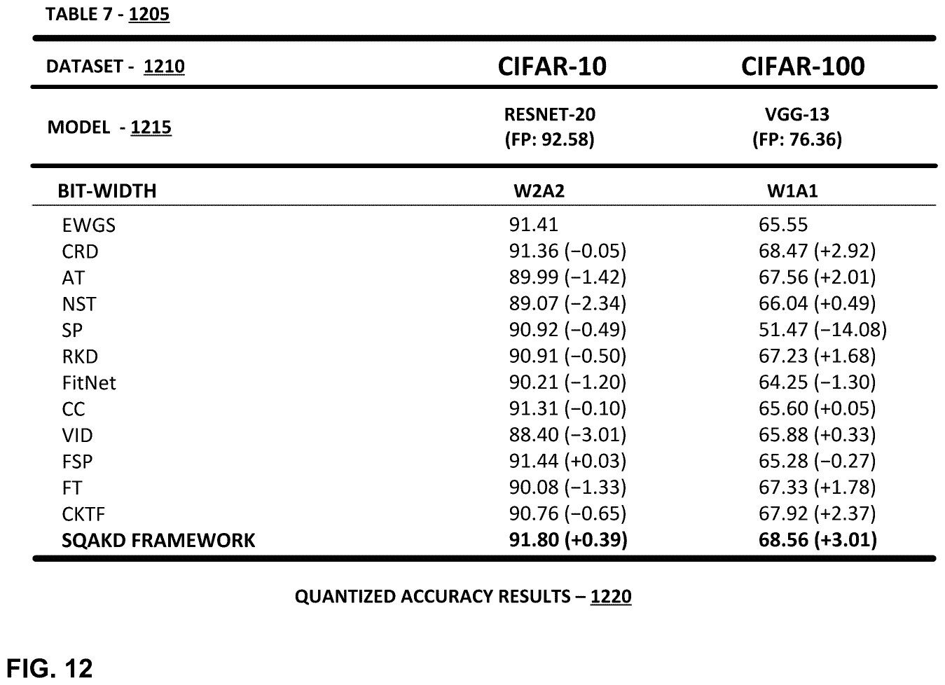

FIG. 12 depicts Table 7 at element 1205 providing a summary of top-1 test accuracy of knowledge distillation (KD) in quantization-aware training (QAT), using EWGS as the quantizer, in accordance with aspects of the disclosure. The bold and light gray numbers inside the parentheses denote the increase and decrease compared to standalone EWGS, respectively.

Dataset 1210 includes CIFAR-10 and CIFAR-100. Model 1215 specifies ResNet-20 for CIFAR-10 with a full-precision (FP) accuracy of 92.58%, and VGG-13 for CIFAR-100 with FP accuracy of 76.36%. Quantized accuracy results 1220 present the top-1 test accuracy of SQAKD framework 170 alongside 11 existing KD methods under quantization using EWGS, with W2A2 precision for CIFAR-10 and W1A1 precision for CIFAR-100.

In the quantized accuracy results 1220, SQAKD framework 170 achieves 91.80% on CIFAR-10 and 68.56% on CIFAR-100, demonstrating a 0.39% improvement over EWGS for CIFAR-10 and a 3.01% improvement for CIFAR-100. None of the existing KD methods consistently enhance EWGS on both datasets, nor do they outperform SQAKD framework 170.

Comparison with supervised KD methods reveals that the 11 existing approaches fail to converge under unsupervised conditions. Therefore, only their supervised performance is shown. Evaluation results indicate that SQAKD framework 170 surpasses these supervised KD methods by margins ranging from 0.36% to 3.4% on CIFAR-10 and from 0.09% to 17.09% on CIFAR-100.

The greater improvement observed on CIFAR-100 may be attributed to its higher complexity and number of classes compared to CIFAR-10. This results in more significant information loss during quantization, which is effectively mitigated by SQAKD framework 170 through knowledge transfer from the full-precision teacher model.

As shown in FIG. 12, and with reference again to FIG. 7, a detailed comparison is provided between SQAKD framework 170 and FSP, the second-best performing KD method, under identical quantization settings using EWGS as the quantizer.

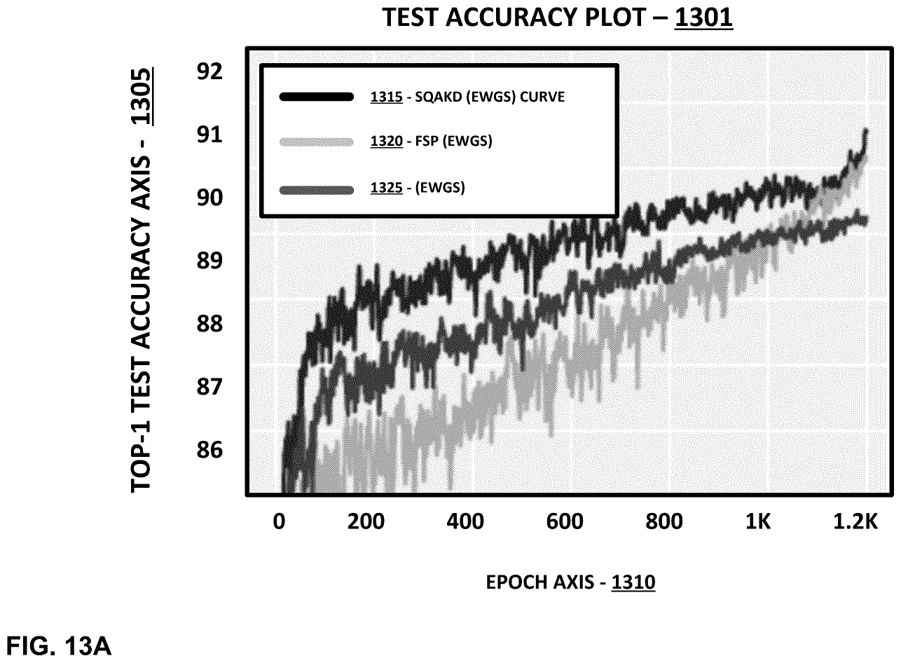

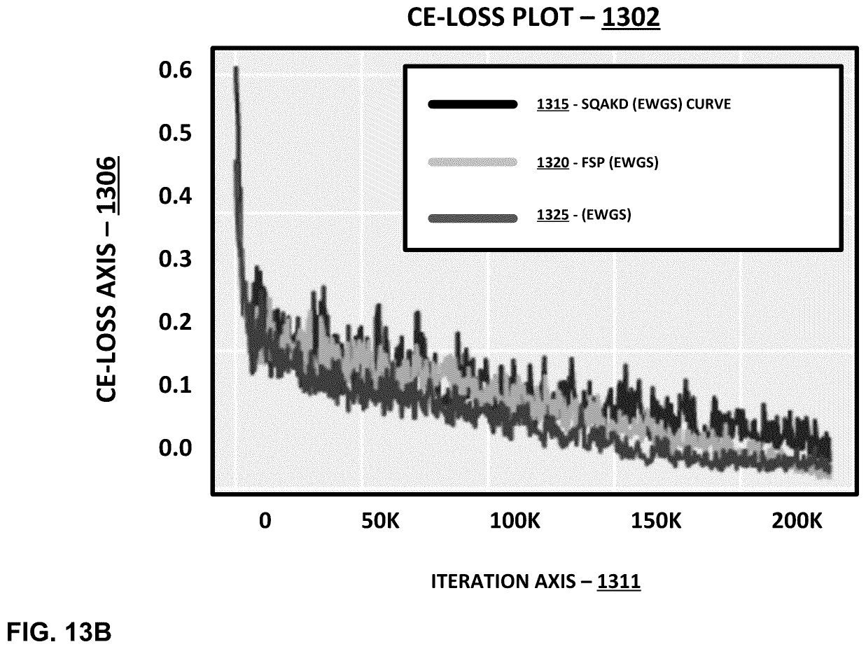

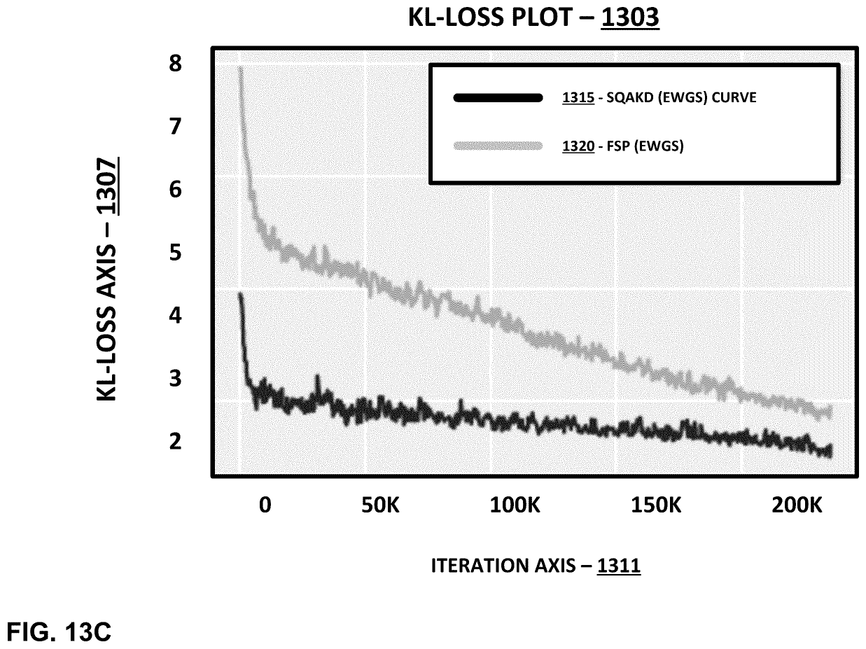

FIGS. 13A, 13B, and 13C provide an illustration of top-1 test accuracy axis 1305 (see FIG. 13A), CE-loss axis 1306 (see FIG. 13B), and KL-loss axis 1307 (see FIG. 13C) of 1325 (EWGS), 1320 FSP (EWGS), and 1315 SQAKD (EWGS) curve in each 1310 epoch axis or 1311 iteration axis during training on 2-bit ResNet-20 with CIFAR-10, in accordance with aspects of the disclosure.

FIG. 13A illustrates that on 2-bit ResNet-20 with CIFAR-10, 1315 SQAKD (EWGS) curve converges significantly faster than both 1325 (EWGS) and 1320 FSP (EWGS), whereas 1320 FSP (EWGS) impedes the convergence speed of 1325 (EWGS). As shown in FIG. 13B, for CE-loss axis 1306, 1315 SQAKD (EWGS) curve achieves performance comparable to 1320 FSP (EWGS) and 1325 (EWGS). FIG. 13C illustrates that, for KL-loss axis 1307, 1315 SQAKD (EWGS) curve converges faster and achieves a lower final value than 1320 FSP (EWGS), which in turn converges more slowly than 1315 SQAKD (EWGS) curve.

These findings validate that 1315 SQAKD (EWGS) curve is sufficient for minimizing both CE-loss axis 1306 and KL-loss axis 1307, resulting in faster and more effective distillation. The results confirm that, in the context of quantization, 1315 SQAKD (EWGS) curve outperforms 1320 FSP (EWGS) and 1325 (EWGS) in both convergence speed and final test accuracy.

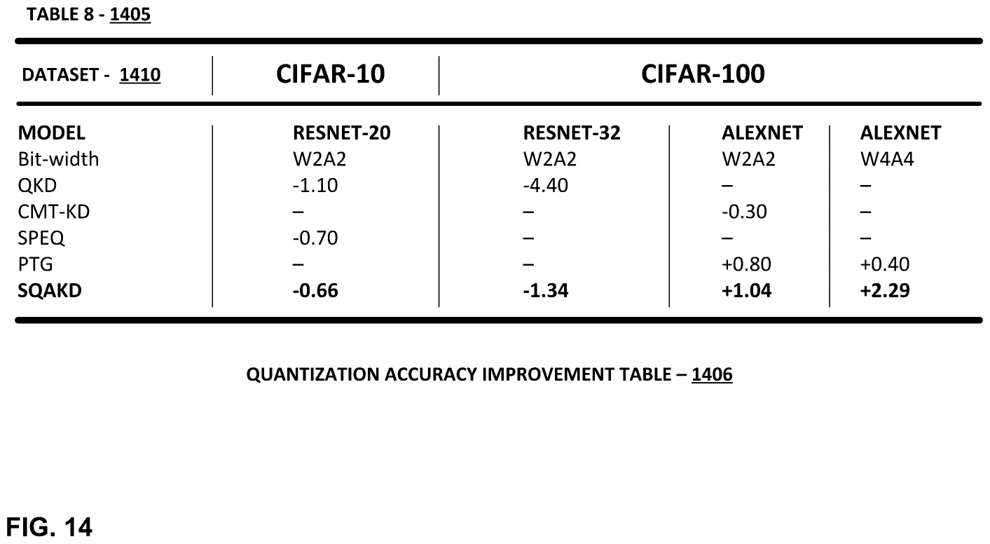

FIG. 14 depicts Table 8 at element 1405 providing a comparison of SQAKD framework 170 with KD-integrated QAT methods, in accordance with aspects of the disclosure. Dataset 1410 corresponds to benchmark datasets CIFAR-10 and CIFAR-100. Quantization accuracy improvement table 1406 provides comparative values across different model architectures and quantization settings. Accuracy drop or improvement is measured by comparing the top-1 test accuracy of low-bit models with their full-precision counterparts. Negative values in quantization accuracy improvement table 1406 indicate an accuracy drop, while positive values denote an improvement in accuracy.

Table 8 1405 includes the results for ResNet-20, ResNet-32, and AlexNet, under multiple quantization configurations: W2A2 and W4A4. The values listed in quantization accuracy improvement table 1406 are organized by model type, bit-width, and training method. Each column under CIFAR-10 and CIFAR-100 reports the accuracy delta for each method: QKD, CMT-KD, SPEQ, PTG, and SQAKD. Absence of reported values is indicated by an em dash.

Comparison with state-of-the-art methods: applying both quantization-aware training (QAT) and knowledge distillation (KD), quantization accuracy improvement table 1406 as presented in FIG. 14 compares SQAKD framework 170 with KD-integrated QAT methods on CIFAR-10 and CIFAR-100. Values for the KD-integrated QAT methods were obtained from prior published results. Missing values are denoted with em dashes where no result was available.

SQAKD framework 170 outperformed all baseline methods in all tested scenarios. Specifically, for 2-bit ResNet models (ResNet-20 on CIFAR-10 and ResNet-32 on CIFAR-100), all methods showed an accuracy drop, while SQAKD framework 170 achieved the smallest drop, ranging from 0.04% to 3.06% less than the baselines. For AlexNet on CIFAR-100, only SQAKD framework 170 and PTG achieved positive accuracy improvements. SQAKD framework 170 outperformed PTG with improvements of +1.04% vs. +0.80% for 2-bit quantization and +2.29% vs. +0.40% for 4-bit quantization. In contrast, CMT-KD showed a −0.30% degradation.

The prior KD-integrated QAT methods require large labeled datasets, careful hyperparameter tuning to balance multiple loss terms (e.g., three parameters in the loss function of CMT-KD), and complex multi-phase training (e.g., QKD requires three-phase training). In contrast, SQAKD framework 170 is self-supervised, does not require loss balancing hyperparameters, and uses a simple, single-phase training regime. These features make SQAKD framework 170 a more efficient and practical approach for low-bit model training.

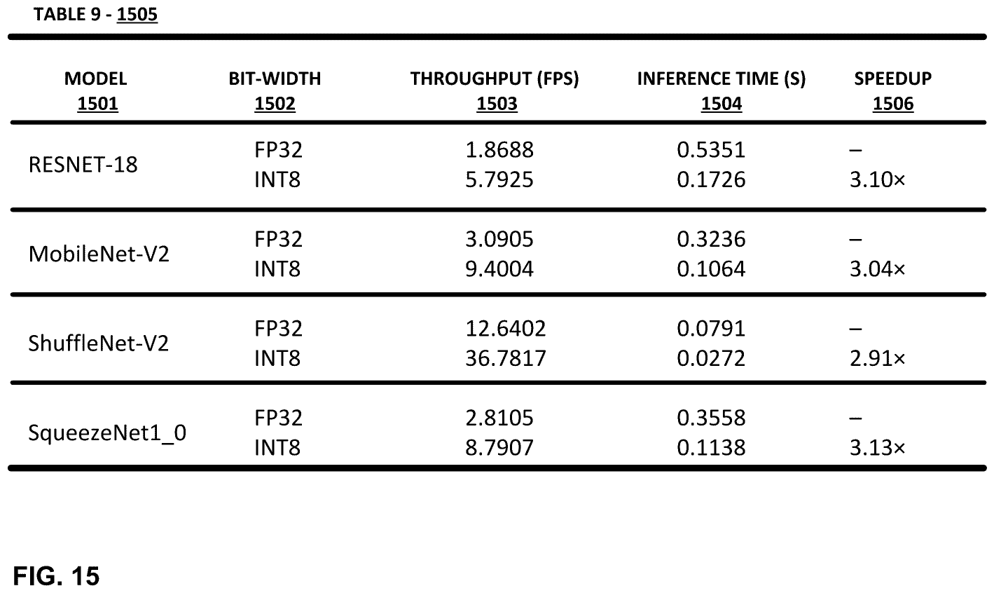

FIG. 15 depicts Table 9 at element 1505 providing a summary of inference throughput, inference time, and speedup results across different deep learning models on Jetson Nano, in accordance with aspects of the disclosure. Table 9 at element 1505 includes model column 1501, bit-width column 1502, throughput (fps) column 1503, inference time (s) column 1504, and speedup column 1506.

Model column 1501 lists a set of four neural network architectures used for benchmarking. Each model name is stacked with two entries per group, one for full-precision floating point and one for quantized execution. These include ResNet-18, MobileNet-V2, ShuffleNet-V2, and SqueezeNet1_0.

Bit-width column 1502 indicates the numerical precision used during inference. For each model, results are shown for both FP32 and INT8 inference.

Throughput (fps) column 1503 provides measured inference throughput in frames per second for each configuration. Across all models, INT8 precision shows a substantial increase in throughput relative to FP32.

Inference time (s) column 1504 records the per-frame inference latency for each configuration. INT8 inference shows reduced latency compared to FP32 for each corresponding model.

Speedup column 1506 quantifies the relative performance gain of INT8 inference over FP32, based on throughput. For each model group, FP32 entries show a dash symbol (−), and INT8 entries show a calculated multiplier value such as 3.10× or 2.91×.

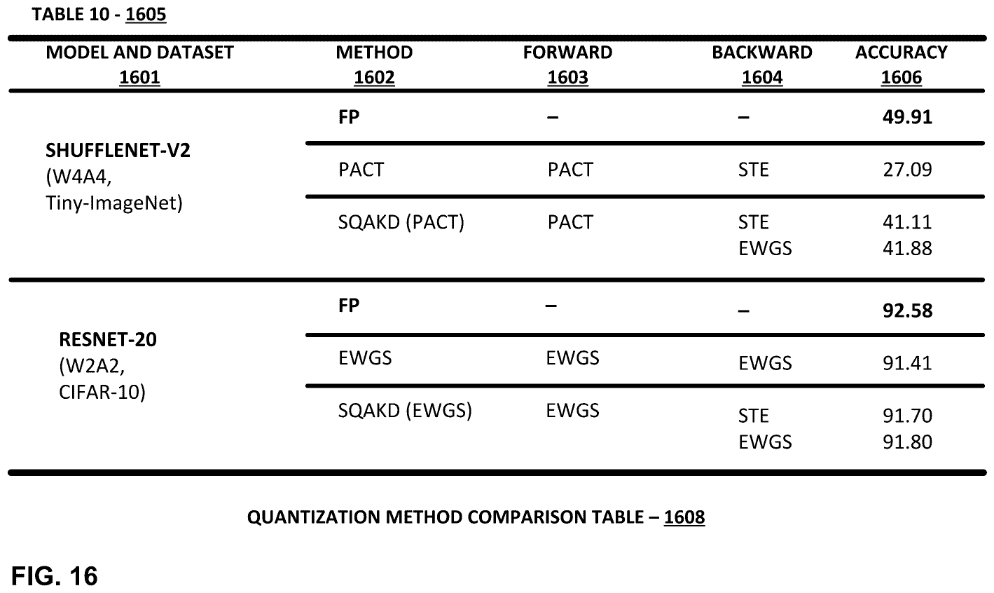

FIG. 16 depicts Table 10 at element 1605 providing a summary of Top-1 test accuracy of different quantization forward and backward combinations, in accordance with aspects of the disclosure. Quantization method comparison table 1608 presents a structured evaluation across multiple quantization schemes. Each row specifies a model and dataset combination 1601 along with the corresponding method 1602, forward 1603 and backward 1604 quantization techniques, and final accuracy 1606.

For ShuffleNet-V2 (W4A4, Tiny-ImageNet), method 1602 includes FP, PACT, and SQAKD (PACT). The FP row uses no quantization, as shown by dashes in forward 1603 and backward 1604, and achieves accuracy 1606 of 49.91. PACT applies quantization only in forward 1603 using PACT and in backward 1604 using STE, resulting in accuracy 1606 of 27.09. SQAKD (PACT) applies PACT in forward 1603 and combines STE and EWGS in backward 1604, yielding accuracy 1606 values of 41.11 and 41.88.

For ResNet-20 (W2A2, CIFAR-10), method 1602 includes FP, EWGS, and SQAKD (EWGS). The FP row again uses no quantization in forward 1603 or backward 1604 and produces accuracy 1606 of 92.58. The EWGS method uses EWGS for both forward 1603 and backward 1604 and achieves accuracy 1606 of 91.41. SQAKD (EWGS) applies EWGS for forward 1603 and combines STE and EWGS in backward 1604, leading to accuracy 1606 values of 91.70 and 91.80.

This configuration highlights the improved performance of the SQAKD framework when integrating advanced backward methods such as EWGS, and demonstrates quantization consistency across different model-dataset pairs.

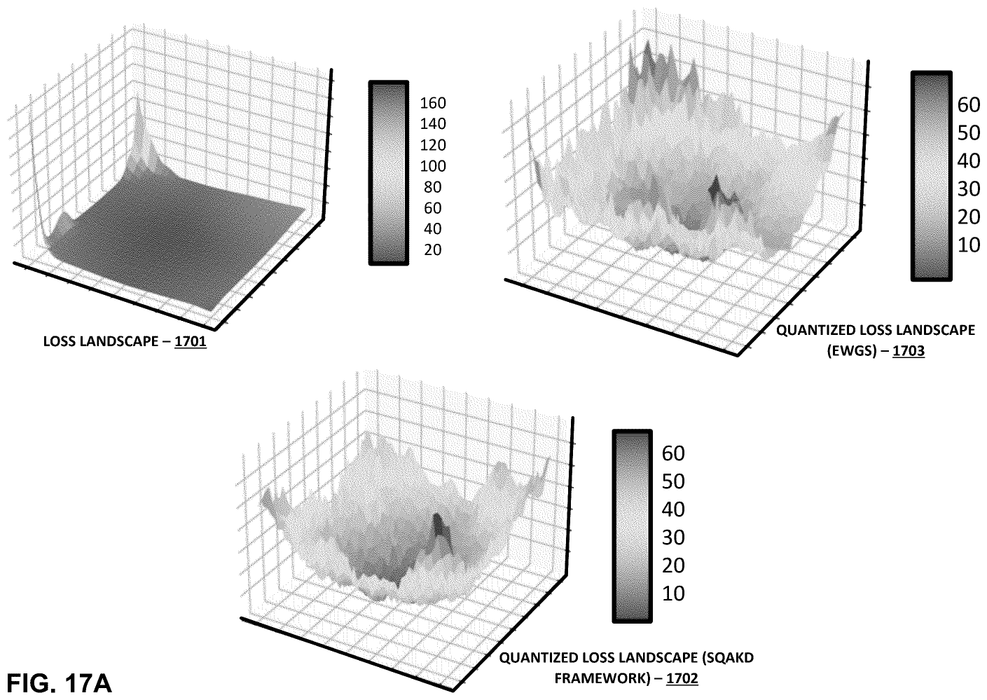

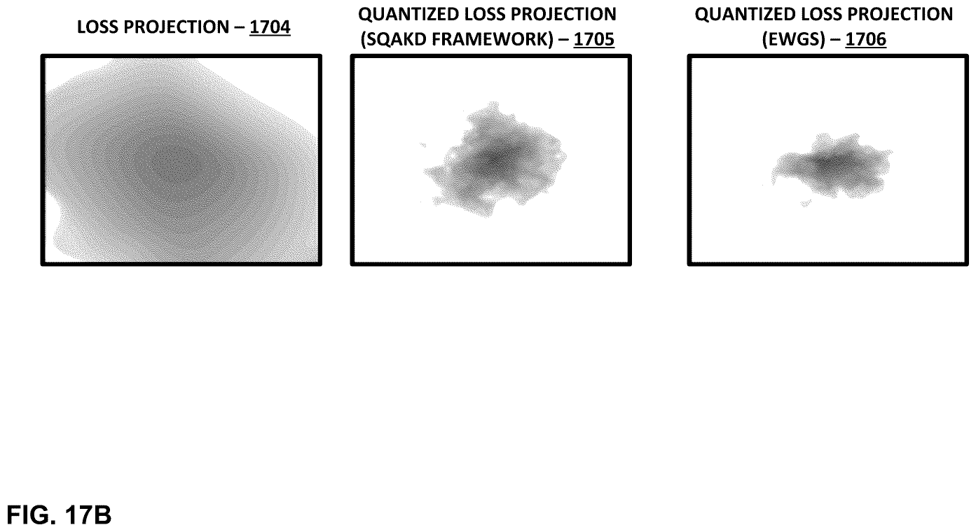

FIGS. 17A and 17B depict 3D loss surfaces, quantized loss landscape, 2D contours, and quantized loss projection, in accordance with aspects of the disclosure.

More particularly, FIGS. 17A and 17B depict 3D loss surfaces (see loss landscape 1701, quantized loss landscape (SQAKD framework) 1702, and quantized loss landscape (EWGS) 1703 in FIG. 17A) and 2D contours (see loss projection 1704, quantized loss projection (SQAKD framework) 1705, and quantized loss projection (EWGS) 1706 in FIG. 17B) for full-precision and 2-bit ResNet-20 using SQAKD framework 170 and EWGS on CIFAR-10.

Inference speedup: The reduction in model complexity, achieved through bit width reduction by SQAKD framework 170, translates to real speed improvements in model inference. Inference experiments conducted using the PyTorch framework and NVIDIA TensorRT on Jetson Nano-a widely used Internet-of-Things (IoT) platform-show that SQAKD framework 170 improves inference speed by approximately 3× for 8-bit quantization across various model architectures, including ResNet-18, MobileNet-V2, ShuffleNet-V2, and SqueezeNet, on Tiny-ImageNet.

Ablation study: Analysis of loss surface: FIGS. 17A and 17B compare the 3D loss surface and the corresponding 2D contour for full-precision ResNet-20 and 2-bit ResNet-20 models trained using SQAKD framework 170 and standalone EWGS on CIFAR-10. Loss landscape 1701 represents the full-precision loss surface. Quantized loss landscape (SQAKD framework) 1702 illustrates the effect of quantization using SQAKD framework 170, and quantized loss landscape (EWGS) 1703 shows the result of using standalone EWGS. Loss projection 1704 corresponds to the 2D contour of loss landscape 1701. Quantized loss projection (SQAKD framework) 1705 and quantized loss projection (EWGS) 1706 correspond respectively to quantized loss landscape (SQAKD framework) 1702 and quantized loss landscape (EWGS) 1703. SQAKD framework 170 enables the quantized model to achieve a flatter and smoother loss surface compared to standalone EWGS. This visualization and analysis of the loss surface of a low-precision model achieved using QAT represents an advancement over prior known methods.

Flexibility for various forward and backward combinations: To demonstrate the flexibility of SQAKD framework 170, forward and backward techniques from SOTA QAT methods such as PACT and EWGS were modularly integrated. Table 10 indicates that, on 4-bit ShuffleNet-V2 with Tiny-ImageNet, SQAKD framework 170 enhances PACT by 14.02% using STE backward and further improves it by 0.77% with EWGS backward. The effectiveness of EWGS backward is attributed to its integration of discretization error into gradient approximation. On 2-bit ResNet-20 with CIFAR-10, SQAKD framework 170 improves EWGS by 0.29% and 0.39% using STE and EWGS backward, respectively.

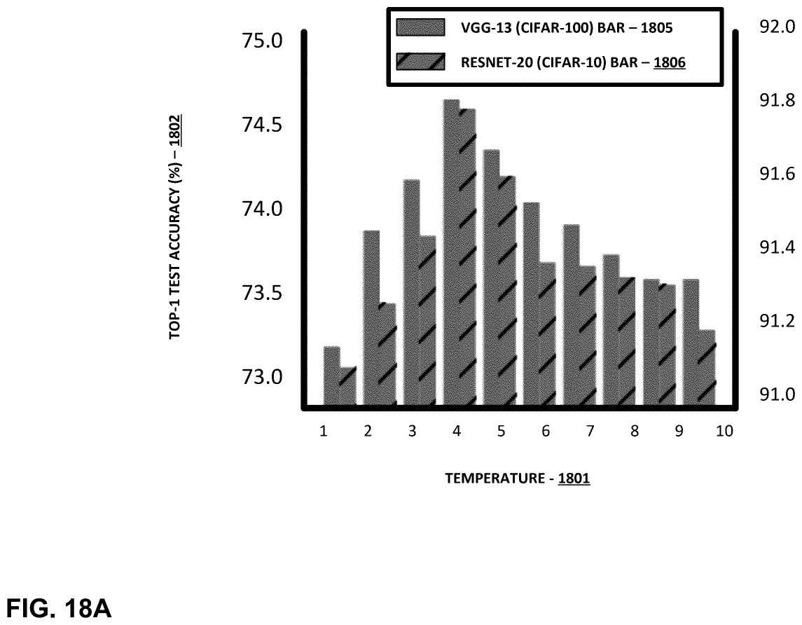

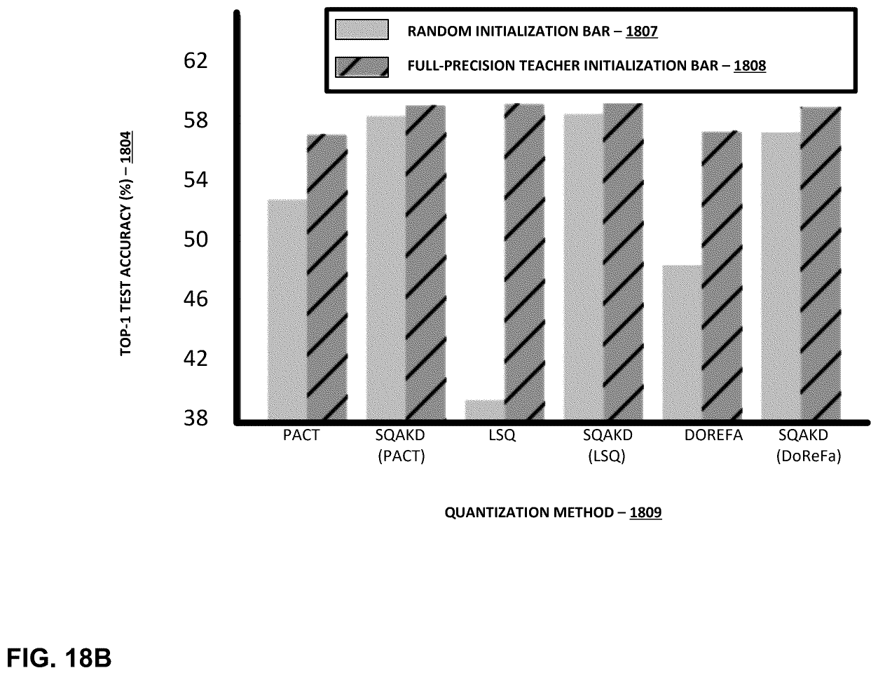

FIGS. 18A-18B depict the effect of temperature on test accuracy as illustrated by temperature 1801 at FIG. 18A, and the effect of initialization strategy as illustrated by quantization method 1809 at FIG. 18B, in accordance with aspects of the disclosure.

Effect of temperature: Temperature ρ, as depicted at FIG. 18A and as defined above at Equation 6, softens the distribution, aiding in the extraction of the teacher's dark knowledge. Experimental investigation over the range ρ∈[1,10] using VGG-13 on CIFAR-100 and ResNet-20 on CIFAR-10 reveals that ρ=4 provides the best performance. Temperature 1801 corresponds to the values shown on the horizontal axis, while top-1 test accuracy (%) 1802 is shown on the vertical axis. VGG-13 (CIFAR-100) bar 1805 and ResNet-20 (CIFAR-10) bar 1806 are plotted against the varying values of temperature 1801. These results align with empirical insights in contrastive knowledge transfer.

Effect of initialization: FIG. 18B shows that initializing either randomly or with the full-precision teacher increases the top-1 test accuracy of PACT, LSQ, and DoReFa by varying amounts (from 0.05% to 18.97%) for 4-bit VGG-11 on Tiny-ImageNet. Quantization method 1809 identifies the different quantization strategies evaluated, and top-1 test accuracy (%) 1804 is shown on the vertical axis. Random initialization bar 1807 and full-precision teacher initialization bar 1808 demonstrate comparative performance across the quantization methods. Initialization with the full-precision teacher consistently outperforms random initialization in all cases.

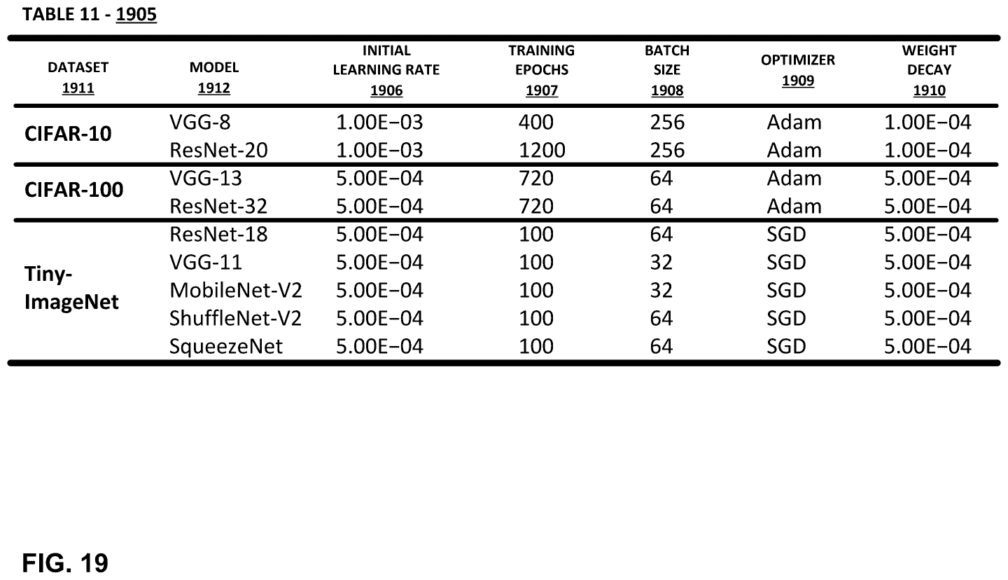

FIG. 19 depicts Table 11 1905 providing a summary of implementation details for the various datasets and models, in accordance with aspects of the disclosure.

Experiment setup—Models and datasets: Extensive experiments were conducted to evaluate the Self-Supervised Quantization-Aware Knowledge Distillation (SQAKD) framework on various image classification datasets as denoted by FIG. 19. These datasets, referenced under dataset 1911, include CIFAR-10, which contains 50,000 RGB images of size 32×32 pixels across 10 classes; CIFAR-100, comprising 50,000 RGB images of the same size but with 100 classes; and Tiny-ImageNet, which features 100,000 images of size 64×64 pixels spread over 200 classes.

Baseline architectures referenced under model 1912 include ResNet and VGG. Lightweight architectures such as MobileNet-V2, ShuffleNet-V2, and SqueezeNet were also evaluated. Model weights were initialized using their corresponding pretrained, full-precision counterparts. Consistent with commonly used experimental settings, the first convolutional layer and the last fully-connected layer were not quantized.

Implementation details: Training was performed using four NVIDIA RTX 2080 GPUs. On Tiny-ImageNet, the initial learning rate 1906 increased to 5.00E−04 linearly over the first 2,500 iterations and then decayed to 0.0 via cosine annealing. For CIFAR-10 and CIFAR-100, the initial learning rate 1906 started at 1.00E−03 and 5.00E−04, respectively, and decayed to 0.0 using a cosine annealing schedule. Basic data augmentation techniques were applied, including random cropping, horizontal flipping, and normalization. Images were cropped to 224×224 for Tiny-ImageNet and 32×32 for CIFAR-10 and CIFAR-100.

Inference experiments were conducted on the Jetson Nano platform using NVIDIA TensorRT. The model was first converted from PyTorch to ONNX, then transformed into a TensorRT engine file, and finally deployed using the TensorRT runtime. The Jetson Nano, a compact computing platform designed for edge computing and artificial intelligence applications, provides robust computing capabilities in a small footprint, making it suitable for deploying AI models in embedded systems and low-power environments. NVIDIA TensorRT, a high-performance deep learning inference library, supports deep learning applications in computationally constrained environments.

Hyper-parameters of baselines: For a fair comparison of state-of-the-art Quantization-Aware Training (QAT) methods, the original open-source code was rerun, achieving results consistent with those reported in the respective papers. The original EWGS code and MQbench code were used for PACT, LSQ, and DoReFa, as the original code for these methods was unavailable. For the 11 knowledge distillation (KD) baselines, the CRD code was used, which is a widely accepted baseline code. The hyperparameters used were strictly those reported in CRD and the original KD papers. For example, state-of-the-art KD methods in the context of QAT are represented by the loss function:

$$L = {L}_{CE} + λ {L}_{Distill} ,$$

where L_{CE} is the cross-entropy loss with labels, where L_{Distill} is the distillation loss for transferring knowledge between the teacher and the student, and where λ controls the weights of the loss terms.

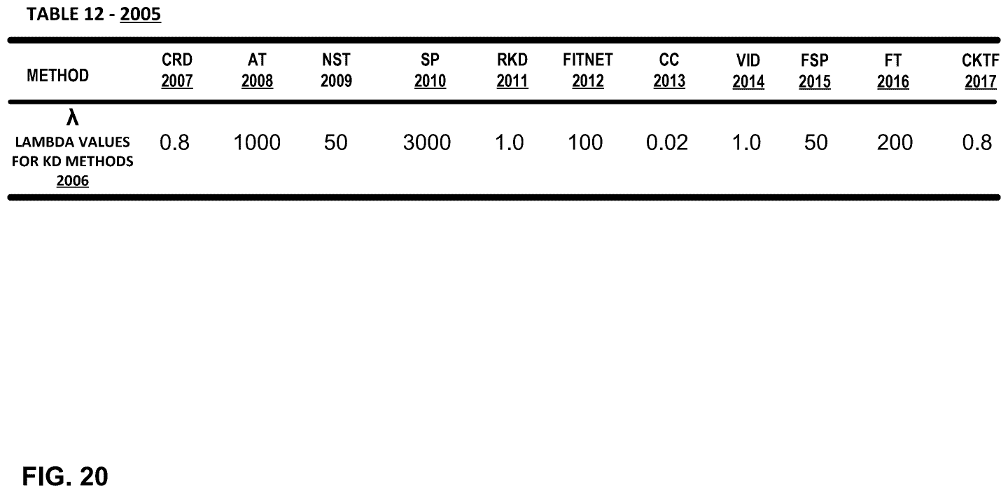

FIG. 20 depicts Table 12 at element 2005 providing a summary of the hyperparameters of related KD methods, in accordance with aspects of the disclosure. Lambda values for KD methods 2006 are listed across CRD 2007, AT 2008, NST 2009, SP 2010, RKD 2011, FitNet 2012, CC 2013, VID 2014, FSP 2015, FT 2016, and CKTF 2017.

Different KD methods have various forms of L_{Distill}, which may include multiple loss terms. For instance, CKTF 2017 includes two loss terms in L_{Distill}, while VID 2014 and FSP 2015 use a number of loss terms equal to the number of intermediate layer pairs between the teacher and student. The hyperparameter settings k are consistent with those used by prior known techniques.

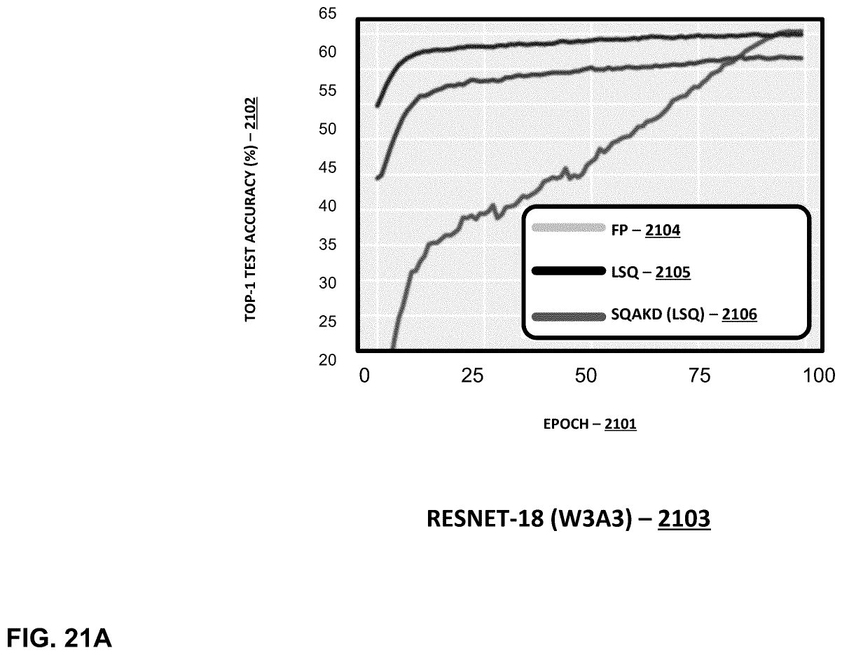

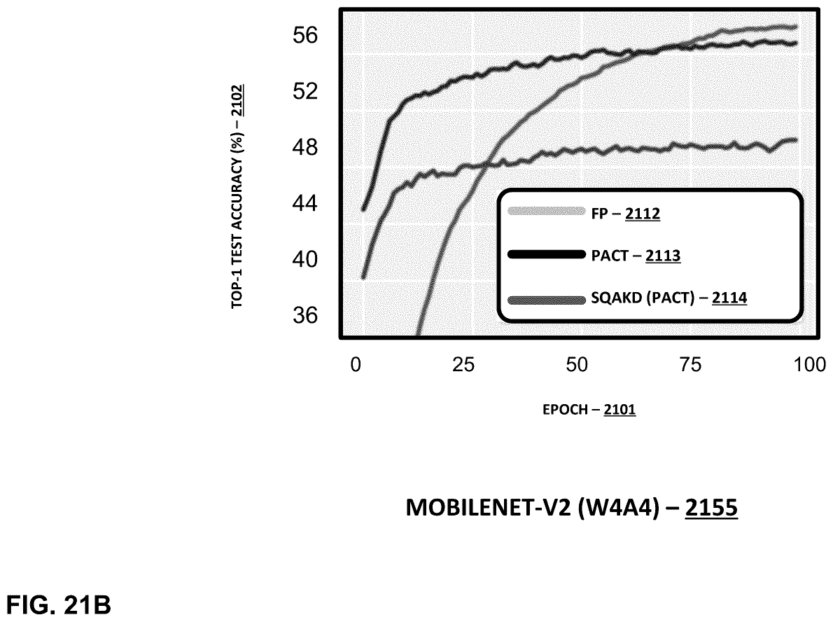

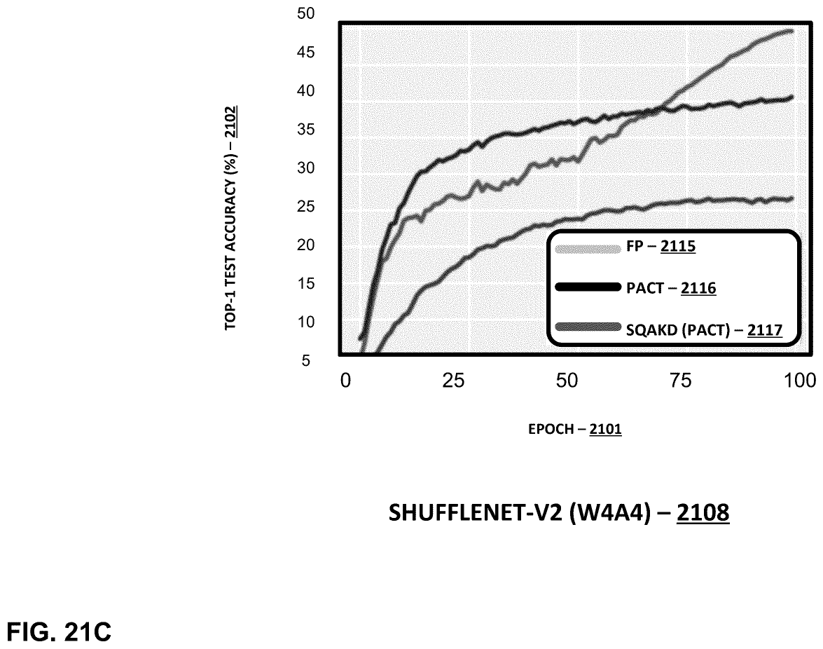

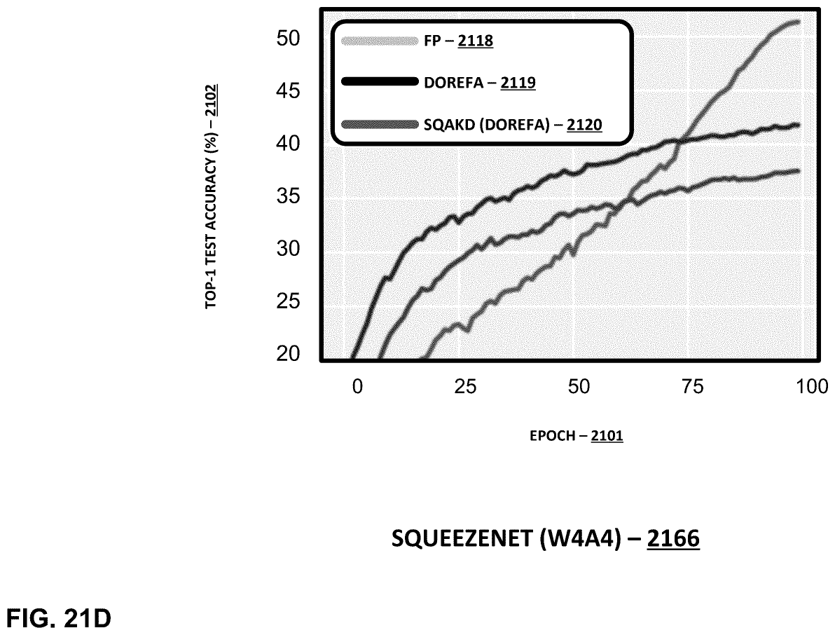

FIGS. 21A, 21B, 21C, and 21D provide an illustration of top-1 test accuracy (%) 2102 evolution of full-precision (FP) models and quantized models using SQAKD and the standalone quantization methods, in accordance with aspects of the disclosure.

In particular, FIGS. 21A-21D provide an illustration of top-1 test accuracy (%) 2102 evolution of full-precision (FP) models and quantized models using SQAKD and the standalone quantization methods, including LSQ 2105, PACT 2113, and DoReFa 2119, in each epoch 2101 during training on Tiny ImageNet.

With reference to FIG. 21A the plot depicts ResNet-18 (W3A3) 2103 using FP 2104, LSQ 2105, and SQAKD (LSQ) 2106. FIG. 21B depicts MobileNet-V2 (W4A4) 2155 using FP 2112, PACT 2113, and SQAKD (PACT) 2114. FIG. 21C depicts ShuffleNet-V2 (W4A4) 2108 using FP 2115, PACT 2116, and SQAKD (PACT) 2117. FIG. 21D depicts SqueezeNet (W4A4) 2166 using FP 2118, DoReFa 2119, and SQAKD (DoReFa) 2120.

Evaluation: Improvements on state-of-the-art quantization-aware training (QAT) methods—Results on Tiny ImageNet: FIGS. 21A-21D illustrate that SQAKD framework 170 enhances the convergence speed across all baseline models, including ResNet-18 2103, MobileNet-V2 2155, ShuffleNet-V2 2108, and SqueezeNet 2166, on Tiny ImageNet. Notably, for MobileNet-V2 2155, SQAKD framework 170 enables the quantized model to achieve convergence significantly faster than full-precision model FP 2112. This advancement is not replicated by standalone QAT methods such as PACT 2113 or DoReFa 2119.

Results on CIFAR-100: The accuracy improvement provided by SQAKD framework 170 is more pronounced for VGG models compared to ResNet models at equivalent quantization levels. For instance, with 1-bit quantization on CIFAR-100, SQAKD enhances the accuracy of VGG-13 by 3.01%, a substantial increase compared to the 0.16% improvement for ResNet-32. Similarly, on CIFAR-10, the accuracy improvement of 1.28% for VGG-8 surpasses the 0.05% gain for ResNet-20. This difference may stem from the simpler, more explicit hierarchical feature structure of VGG models, which aids in recovering accuracy lost during quantization. In contrast, ResNet models, with their skip connections creating irregular and nonlinear pathways, present a more complex challenge for knowledge transfer.

Comparison with state-of-the-art knowledge distillation (KD) methods: Observations indicate that, with supervision by labels, KD techniques that transfer structural knowledge of outputs demonstrate superior performance compared to those that transfer conditionally independent outputs. For instance, on CIFAR-100, when using EWGS as the quantizer, SP and FitNet underperform relative to standalone EWGS. In contrast, CRD, RKD, and CKTF, which capture the structural relations of intermediate representations (CKTF) or penultimate outputs (CRD and RKD), perform well. This observation may be attributed to the fact that capturing the correlations of high-order output dependencies from full-precision models effectively restores the information lost due to quantization and directs the gradient updates of the low-bit model. While knowledge distillation has been explored in existing literature, the performance of various KD methods within the context of quantization has not been previously investigated.

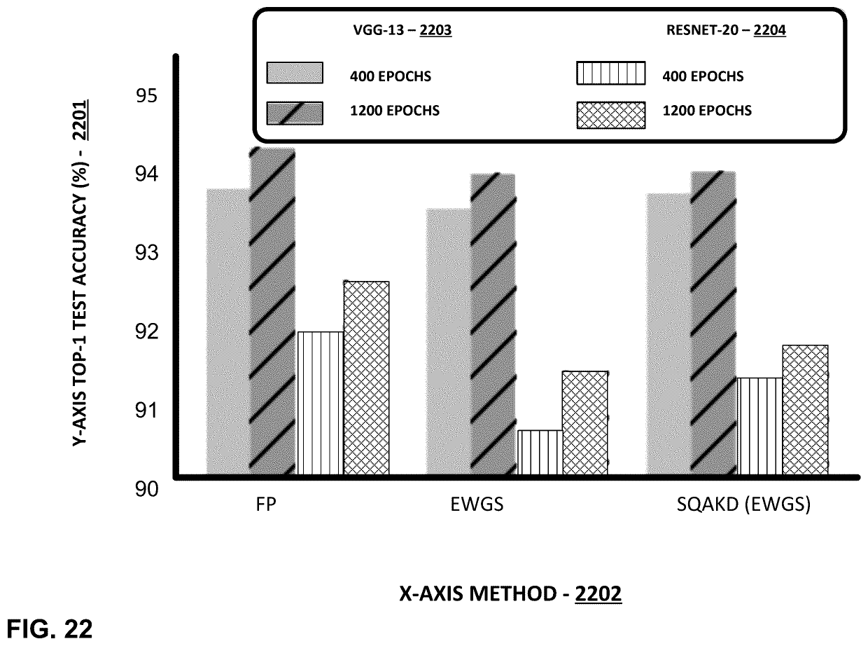

FIG. 22 depicts a y-axis top-1 test accuracy, in accordance with aspects of the disclosure. Specifically, FIG. 22 shows y-axis top-1 test accuracy (%) 2201 plotted against x-axis method 2202. VGG-13 2203 and ResNet-20 2204 are compared under different training durations of 400 epochs 2210 and 1200 epochs 2211, across three methods: FP 2207, EWGS 2208, and SQAKD (EWGS) 2209. Each bar corresponds to test accuracy achieved under the specified epoch count and method.

Effect of training time: Motivated by the proposition that extended training improves test accuracy, the applicability to quantization-aware training was examined. FIG. 22 illustrates that for 2-bit VGG-13 2203 and ResNet-20 2204 on CIFAR-10, regardless of the approach, FP 2207, EWGS 2208, or SQAKD (EWGS) 2209, a 1200 epoch 2211 training duration consistently surpasses 400 epochs 2210, with accuracy gains ranging from 0.28% to 0.77%. Additionally, with an equal number of training epochs, SQAKD (EWGS) 2209 yields consistent improvements over EWGS 2208, with gains of 0.2% to 0.61% for 400 epochs 2210 and 0.03% to 0.31% for 1200 epochs 2211.

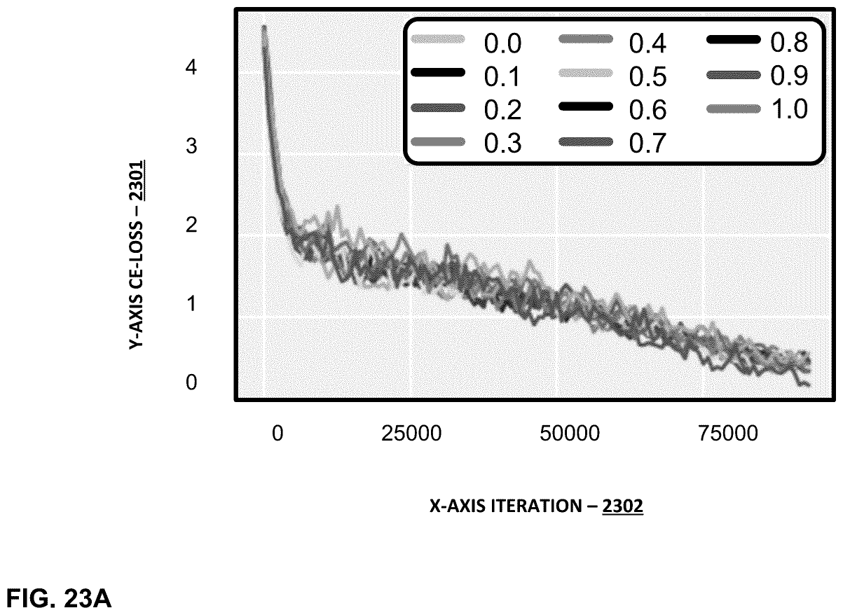

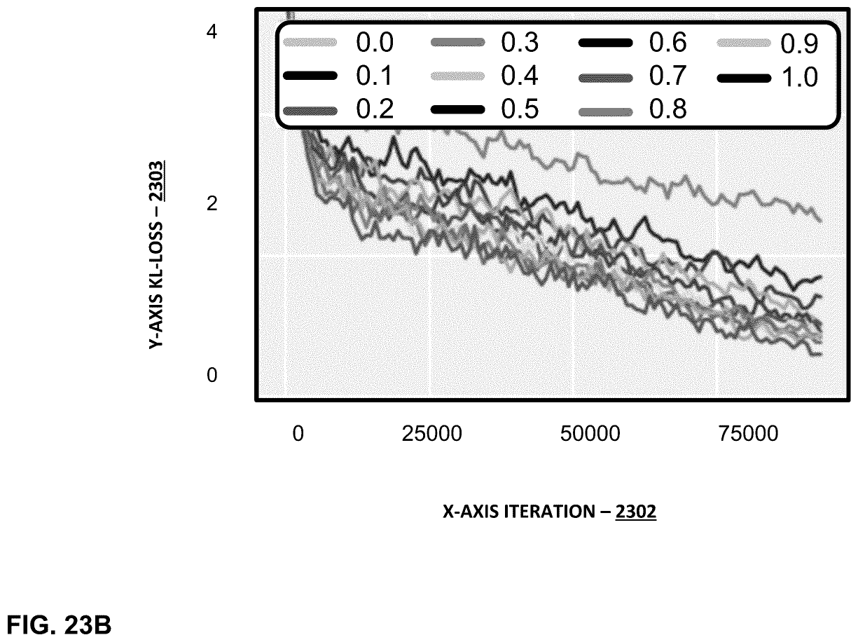

FIGS. 23A and 23B depict the evolution of y-axis CE-Loss 2301 and y-axis KL-Loss 2303, respectively, as a function of x-axis iteration 2302 during the training of 1-bit VGG-13 on CIFAR-100, in accordance with aspects of the disclosure. Each of FIGS. 23A and 23B further includes legend parameter values 2304 that indicate λ∈{0.0, 0.1, . . . , 1.0}. When λ=0.0 within legend parameter values 2304, only y-axis CE-Loss 2301 is minimized. When λ=1.0 within legend parameter values 2304, only y-axis KL-Loss 2303 is minimized.

In addition to the three scenarios illustrated in FIGS. 4A and 4B above, where λ∈{0.0, 0.5, 1.0} as described in Eq. 5, the analysis is extended in FIGS. 23A and 23B to include λ∈{0.0, 0.1, 0.2, 0.3, . . . , 0.9, 1.0} for 1-bit VGG-13 on CIFAR-100. This extension aims to further investigate the relationship between y-axis CE-Loss 2301 and y-axis KL-Loss 2303 as both evolve with x-axis iteration 2302. FIG. 23A shows that y-axis CE-Loss 2301 is reduced across all settings of λ, while FIG. 23B shows that y-axis KL-Loss 2303 decreases more significantly as λ, approaches 1.0. Notably, when λ=1.0 within legend parameter values 2304, minimizing y-axis KL-Loss 2303 concurrently minimizes y-axis CE-Loss 2301. These results validate that minimizing y-axis KL-Loss 2303 alone is sufficient to achieve effective gradient updates in the quantized network.

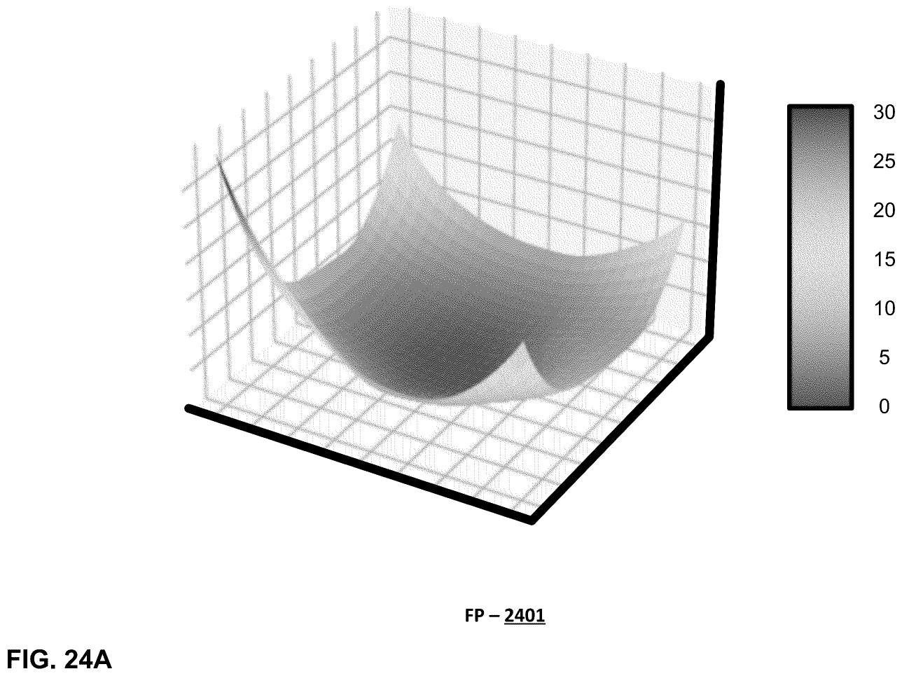

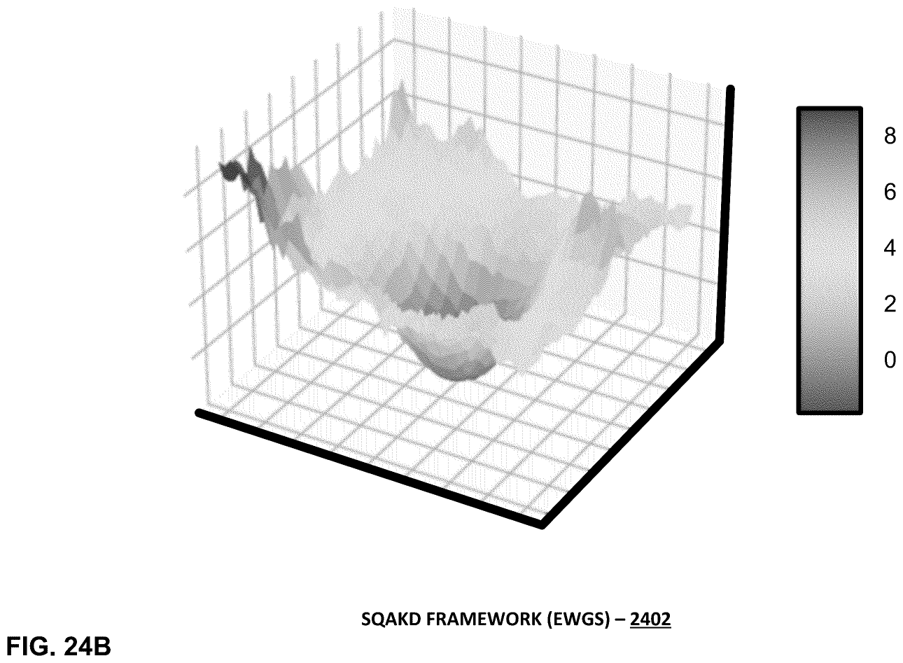

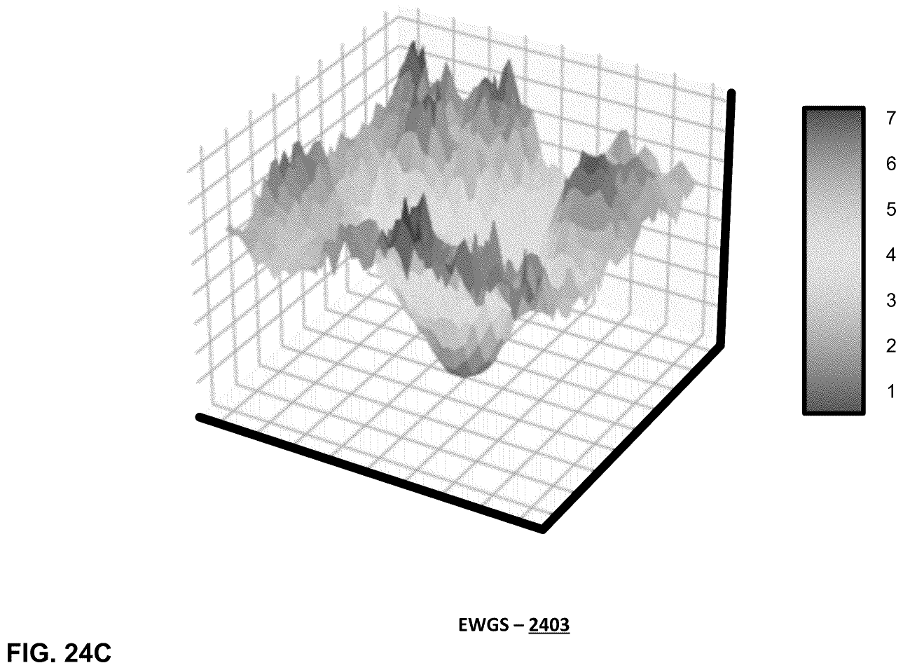

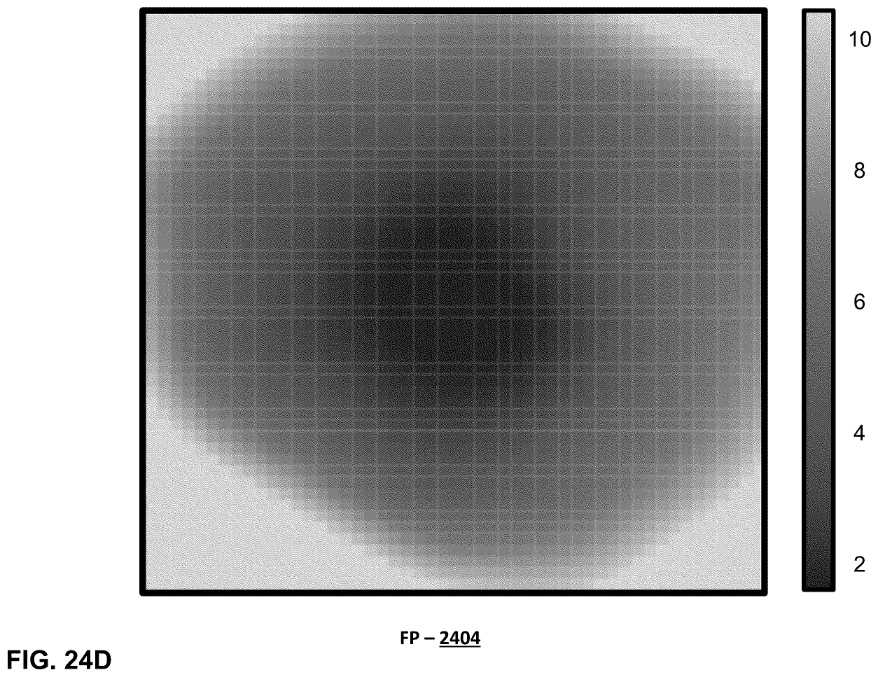

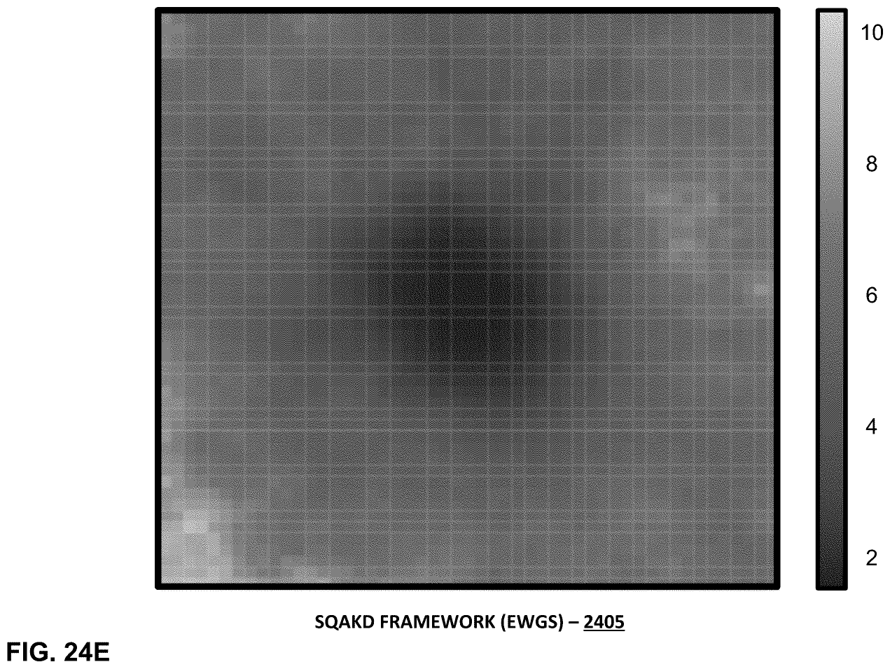

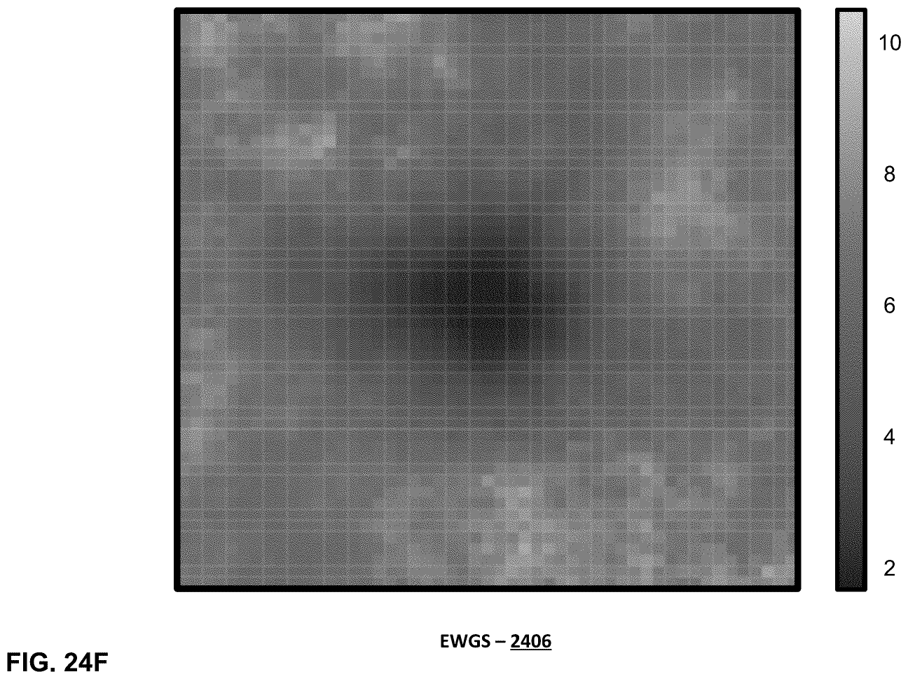

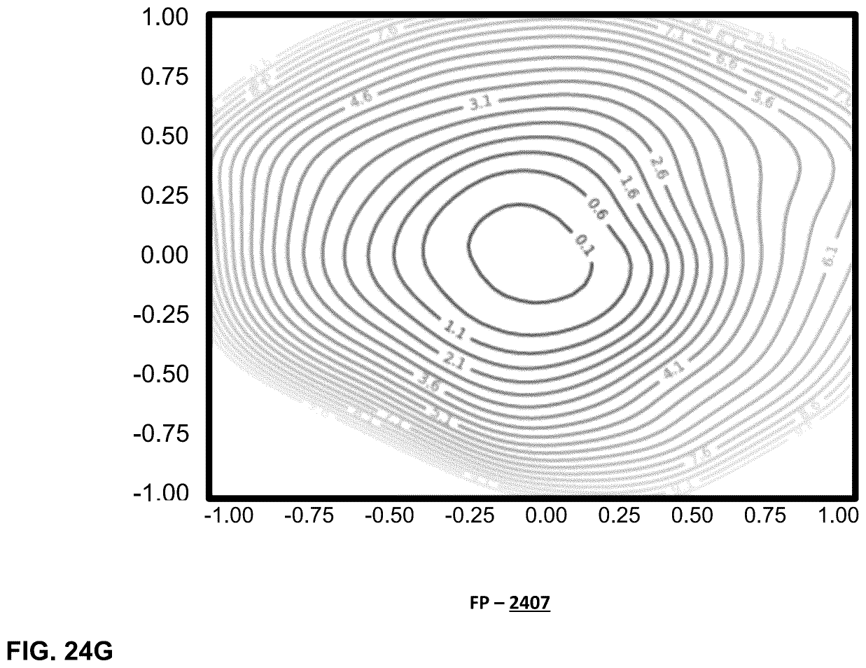

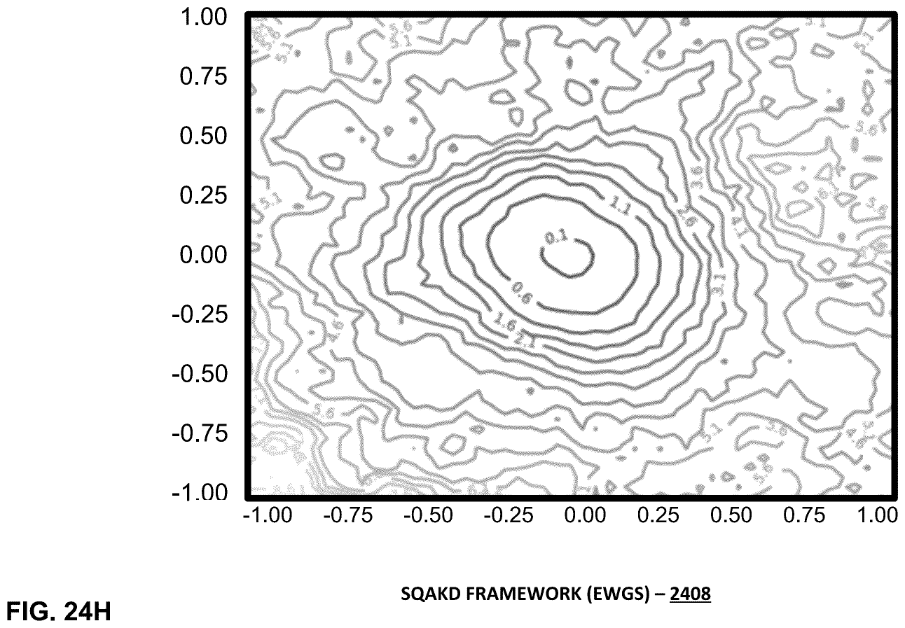

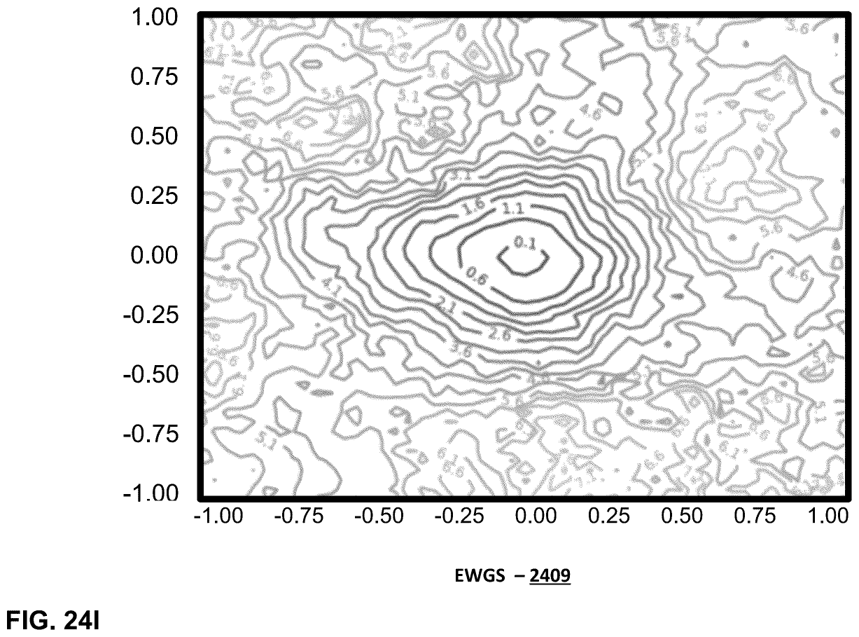

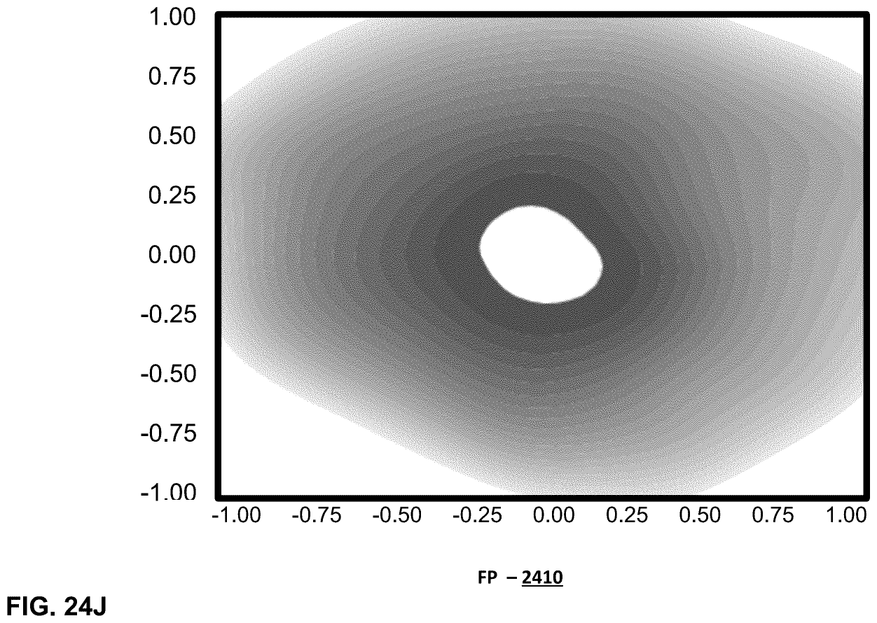

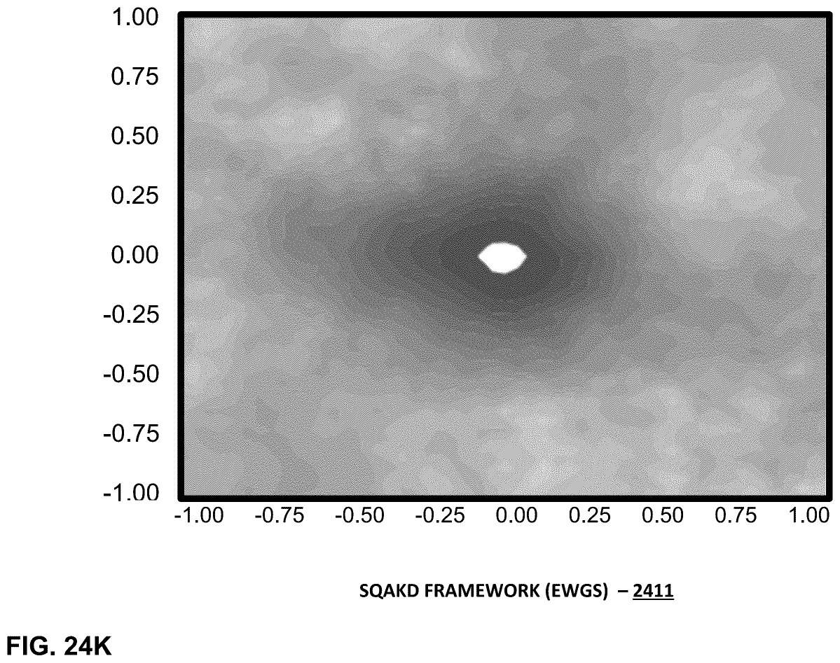

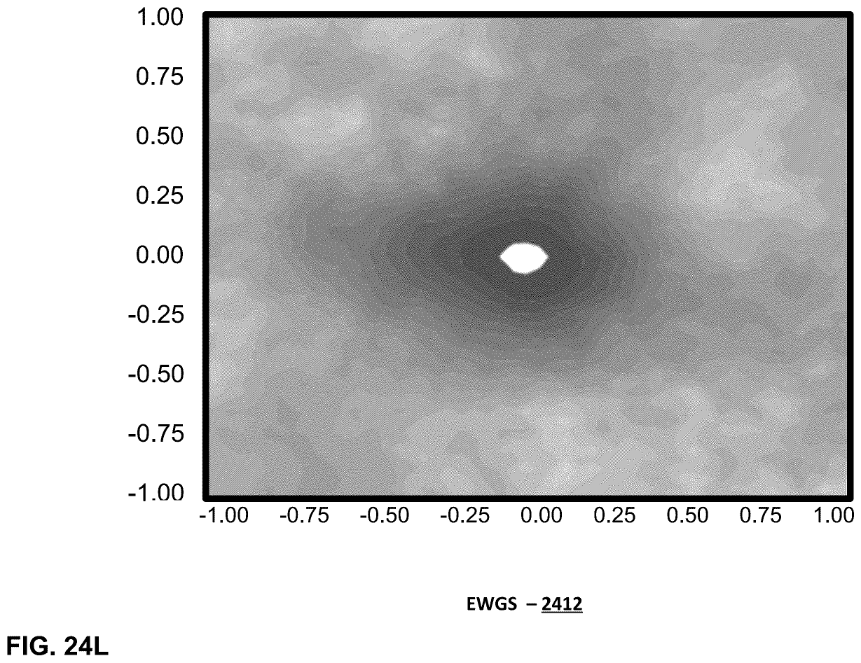

FIGS. 24A-24L illustrate comparative loss surface visualizations for full-precision (FP), standalone EWGS, and SQAKD framework 170 integrating EWGS, in accordance with aspects of the disclosure. Each plot is applied to a 2-bit VGG-8 model trained on CIFAR-10. The figures include 3D surface plots (see FIGS. 24A, 24B, and 24C), 2D heatmaps (see FIGS. 24D, 24E, and 24F), 2D contour plots (see FIGS. 24G, 24H, and 24I), and 2D filled contour plots (see FIGS. 24J, 24K, and 24L). These visualizations provide complementary perspectives on the loss landscape associated with each training configuration and demonstrate the benefits of the proposed framework.

FIG. 24A shows FP 2401, a 3D loss surface for the full-precision VGG-8 model. The plot reveals a deep and smooth convex basin centered at the origin, indicating strong convergence properties and well-behaved gradients during optimization.

FIG. 24B shows SQAKD framework (EWGS) 2402, which corresponds to the 3D loss surface of the 2-bit VGG-8 trained using SQAKD framework 170. The surface retains a smooth structure with moderate undulations, indicating that the quantized model preserves the stability of the original full-precision training dynamics while accommodating the constraints of reduced bit width.

FIG. 24C shows EWGS 2403, the standalone EWGS 3D loss surface. Compared to the previous two, this surface exhibits significant ruggedness and noise, with sharper valleys and irregular peaks, suggesting less stable convergence and higher sensitivity to parameter changes.

FIG. 24D shows FP 2404, the corresponding 2D heatmap projection of the full-precision loss surface. A symmetric and sharply centered dark region indicates low loss values near the minimum, surrounded by progressively lighter gradients that represent increasing loss values.

FIG. 24E shows SQAKD framework (EWGS) 2405, the 2D heatmap representation of the SQAKD-trained quantized model. The central region is compact and well-defined, resembling the full-precision configuration, though with slight diffusion around the outer contours.

FIG. 24F shows EWGS 2406, the heatmap for the standalone EWGS-trained model. The heatmap is noisier and less regular, with a more dispersed central minimum and surrounding artifacts that reflect instability in the loss surface.

FIG. 24G shows FP 2407, the 2D contour visualization of the full-precision model. The contours are elliptical and concentric, with even spacing that implies consistent gradient flow and a well-formed convex landscape.

FIG. 24H shows SQAKD framework (EWGS) 2408, the contour plot of the quantized model trained using SQAKD framework 170. The contours are similarly concentric but exhibit slight perturbations at the outer rings, illustrating minimal deviation from the full-precision behavior.

FIG. 24I shows EWGS 2409, the standalone EWGS contour plot. The contours are jagged and irregular, with uneven spacing and fragmented paths indicating loss function roughness and suboptimal convergence characteristics.

FIG. 24J shows FP 2410, the filled contour visualization for the full-precision loss surface. It reinforces the presence of a centralized low-loss region, smoothly transitioning into surrounding higher-loss zones.

FIG. 24K shows SQAKD framework (EWGS) 2411, the filled contour for the SQAKD-trained quantized model. The inner region remains clearly delineated, consistent with a flatter optimization landscape conducive to stable training.

FIG. 24L shows EWGS 2412, the filled contour for the standalone EWGS-trained model. It displays significant texture noise and diffuse loss regions, confirming the unstable landscape seen in the 3D and 2D projections.

As demonstrated by the collective evidence in FIGS. 24A-24L, SQAKD framework 170 enables the quantized 2-bit VGG-8 model to approximate the loss landscape characteristics of the full-precision baseline more closely than the standalone EWGS. In particular, SQAKD framework 170 produces a smoother and flatter loss surface, indicating improved generalization and robustness in training.

SQAKD framework 170 facilitates self-supervised optimization without requiring labeled training data, lowering the barrier for deploying quantization-aware training (QAT) in practical applications. Its alignment of forward and backward dynamics results in well-behaved gradients across the quantized parameter space, while avoiding the need for hand-tuned hyperparameters or auxiliary losses. SQAKD framework 170 thus supports efficient and scalable training workflows.

Additionally, the structural properties revealed in FIGS. 24A-24L suggest that SQAKD framework 170 may be extended to further improve quantization performance across diverse model architectures and datasets. The ability to preserve loss surface fidelity under bit-restricted constraints positions SQAKD framework 170 as a valuable advancement in knowledge distillation and QAT methodology.

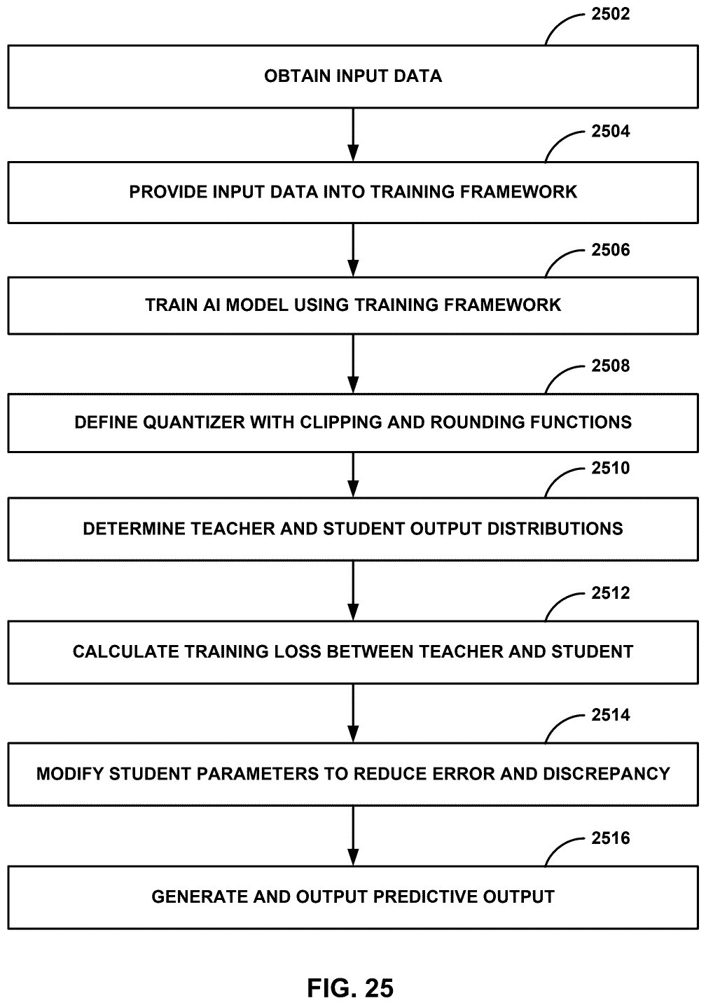

FIG. 25 is a flow diagram illustrating an example method for training and applying an artificial intelligence (AI) model using a teacher-student quantization framework, in accordance with aspects of the disclosure. FIG. 25 is described with respect to computing device 100 and systems or processing circuitry as described in relation to FIGS. 1-24. However, the techniques of FIG. 25 may be performed by different components of computing device 100 or by additional or alternative systems.

Processing circuitry of computing device 100 may be configured to obtain input data (2502). For example, the processing circuitry may be configured to obtain input data for training an artificial intelligence model (AI model).

Processing circuitry of computing device 100 may be configured to provide the input data into a training framework (2504). For example, the processing circuitry may be configured to provide the input data into a training framework having both a teacher layer providing target outputs and a student layer configured to learn to approximate the target outputs.

Processing circuitry of computing device 100 may be configured to train the AI model using the training framework (2506). For example, the processing circuitry may be configured to train the AI model using the training framework by executing a training routine that includes defining a quantizer, calculating teacher and student output distributions, computing a training loss between the outputs, and updating student model parameters based on the loss.

Processing circuitry of computing device 100 may be configured to define a quantizer with clipping and rounding functions (2508). For example, the processing circuitry may be configured to define a quantizer that includes a clipping function and a rounding function to convert full-precision data derived from the input data to quantized data.

Processing circuitry of computing device 100 may be configured to determine teacher and student output distributions (2510). For example, the processing circuitry may be configured to determine a first output distribution for the input data from the teacher layer of the training framework using the full-precision data, and to determine a second output distribution for the input data from the student layer of the training framework using the quantized data.

Processing circuitry of computing device 100 may be configured to calculate training loss between teacher and student (2512). For example, the processing circuitry may be configured to calculate a training loss between the first output distribution from the teacher layer and the second output distribution from the student layer.

Processing circuitry of computing device 100 may be configured to modify student parameters to reduce error and discrepancy (2514). For example, the processing circuitry may be configured to modify training parameters of a quantized network of the student layer to reduce discretization error and prediction discrepancy between the quantized network of the student layer and a full-precision network of the teacher layer.

Processing circuitry of computing device 100 may be configured to generate and output predictive output (2516). For example, the processing circuitry may be configured to generate new predictive output from the AI model using the quantized network of the student layer trained on the input data using the training framework, and to output the predictive output.

In this way, FIG. 25 illustrates an example method for performing quantization-aware training of artificial intelligence models using a teacher-student framework, enabling predictive performance in a quantized network that closely approximates that of a corresponding full-precision model.

This disclosure includes the following examples.

Example 1—A method comprising: obtaining input data for training an artificial intelligence model (AI model); providing the input data into a training framework having both a teacher layer providing target outputs and a student layer configured to learn to approximate the target outputs; training the AI model using the training framework, wherein training the AI model includes: defining a quantizer that includes a clipping function and a rounding function to convert full-precision data derived from the input data to quantized data; determining a first output distribution for the input data from the teacher layer of the training framework using the full-precision data; determining a second output distribution for the input data from the student layer of the training framework using the quantized data; calculating a training loss between the first output distribution from the teacher layer and the second output distribution from the student layer; and modifying training parameters of a quantized network of the student layer to reduce discretization error and prediction discrepancy between the quantized network of the student layer and a full-precision network of the teacher layer; generating new predictive output from the AI model using the quantized network of the student layer trained on the input data using the training framework; and outputting the predictive output.

Example 2—The method of example 1, further comprising: providing the input data concurrently to the teacher layer and the student layer, wherein the teacher layer includes a full-precision network and further wherein the student layer includes a quantized network with less precision than the full-precision network of the teacher layer.

Example 3—The method of example 1, further comprising: determining a Kullback-Leibler type divergence loss (KL-loss) between the first output distribution from the teacher layer and the second output distribution from the student layer; and minimizing the KL-loss between the first output distribution from the teacher layer and the second output distribution from the student layer using back-propagation.

Example 4—The method of example 3, further comprising: minimizing a loss function that is a linear combination of KL-Loss and cross-entropy loss, using a hyperparameter to configure a weighting between the KL-Loss and the cross-entropy loss.

Example 5—The method of example 3, wherein training the AI model using the training framework includes: applying self-supervised knowledge distillation using weights of the student layer iteratively updated based on the KL-loss between the teacher layer and the student layer using the input data; wherein the input data is unlabeled; and wherein teacher layer weights remain fixed during the training the AI model using the training framework.

Example 6—The method of example 1, wherein the training framework implements a Self-Supervised Quantization-Aware Knowledge Distillation framework (SQAKD framework).

Example 7—The method of example 1, further comprising: measuring a difference between the first output distribution from the teacher layer and the second output distribution from the student layer; and training the student layer using transfer learning from the teacher layer including minimizing the training loss between the first output distribution from the teacher layer and the second output distribution from the student layer.

Example 8—The method of example 1, further comprising: calculating the training loss between the first output distribution from the teacher layer and the second output distribution from the student layer; wherein the training loss is defined as a linear combination of cross-entropy loss with labels and distillation losses between the first output distribution from the teacher layer and the second output distribution from the student layer.

Example 9—The method of example 8: wherein the distillation losses between the first output distribution from the teacher layer and the second output distribution from the student layer represented by a term L are configurable using a hyperparameter λ, according to: L=(1−λ)L_{CE}+λL_{Distill}; wherein L_{CE} represents Cross-Entropy Losses; and wherein the distillation losses represented by a term L_{Distill} may be a single Kullback-Leibler divergence loss (KL-loss) or multiple intermediate-representation-based contrastive losses.

Example 10—The method of example 1: wherein the quantizer, represented by Quant (⋅), applies the clipping function, represented by Clip(⋅), to restrict the full-precision data, represented by a term x, to a limited range to generate a full-precision latent representation, represented by the term x_{c}, according to:

$${x}_{c} = Clip ( x , {\{ {p}_{i} \}}_{i = 1}^{i = {K}_{c}} , v , m ) ;$$

wherein X_{c}, represents a lower bound of the limited range; wherein m represents an upper bound of the limited range; wherein K_{c} represents a quantity of parameters; and wherein

$${\{ {p}_{i} \}}_{i = 1}^{i = {K}_{c}}$$

denotes a set of trainable parameters used for quantization.

Example 11—The method of example 1, further comprising: iteratively modifying the training parameters of the quantized network of the student layer to reduce discretization error and prediction discrepancy between the quantized network of the student layer and the full-precision network of the teacher layer; and wherein the iterative modifying of the training parameters includes progressively reducing a bit width parameter using the rounding function of the quantizer to map full-precision data to smaller discrete quantization points, and wherein the iteratively modifying includes performing knowledge distillation over multiple stages or network layers of the student layer during the training.

Example 12—The method of example 1, further comprising: applying back-propagation with gradient approximation to integrate discretization error to determine the training parameters configured to reduce the discretization error and the prediction discrepancy between the quantized network of the student layer and a full-precision network of the teacher layer.

Example 13—The method of example 12, further comprising: applying the gradient approximation using a Straight-Through Estimator (STE) or using a modified STE to incorporate the discretization error.

Example 14—The method of example 12, further comprising: determining the gradient approximation using the discretization error based on a difference between the full-precision data derived from the input data and the quantized data.

Example 15—The method of example 1, wherein training the AI model using the training framework includes: applying self-supervised knowledge distillation using a temperature parameter to adjust the first output distribution for the input data from the teacher layer using the full-precision data; and scaling logits of the first output distribution from the teacher layer and the second output from the student layer using the temperature parameter before calculating a KL-divergence loss between the first output distribution from the teacher layer and the second output distribution from the student layer to reduce variability within the first output distribution and the second output distribution.

Example 16—A system comprising: processing circuitry; non-transitory computer readable media; and instructions that, when executed by the processing circuitry, configure the processing circuitry to: obtain, by the processing circuitry, input data for training an artificial intelligence model (AI model); provide, by the processing circuitry, the input data into a training framework having both a teacher layer providing target outputs and a student layer configured to learn to approximate the target outputs; train the AI model using the training framework, wherein to train the AI model includes the instructions, when executed, to further configure the processing circuitry to: define, using the training framework, a quantizer that includes a clipping function and a rounding function to convert full-precision data derived from the input data to quantized data; determine, using the training framework, a first output distribution for the input data from the teacher layer of the training framework using the full-precision data; determine, using the training framework, a second output distribution for the input data from the student layer of the training framework using the quantized data; calculate, using the training framework, a training loss between the first output distribution from the teacher layer and the second output distribution from the student layer; and modify, using the training framework, training parameters of a quantized network of the student layer to reduce discretization error and prediction discrepancy between the quantized network of the student layer and a full-precision network of the teacher layer; generate, by the processing circuitry, new predictive output from the AI model using the quantized network of the student layer trained on the input data using the training framework; and output, by the processing circuitry, the predictive output.

Example 17—The system of example 16, wherein the instructions, when executed by the processing circuitry, further configure the processing circuitry to: provide the input data concurrently to the teacher layer and the student layer, wherein the teacher layer includes a full-precision network and further wherein the student layer includes a quantized network with less precision than the full-precision network of the teacher layer.

Example 18—The system of example 16, wherein the instructions, when executed by the processing circuitry, further configure the processing circuitry to: determine a Kullback-Leibler type divergence loss (KL-loss) between the first output distribution from the teacher layer and the second output distribution from the student layer; and minimize the KL-loss between the first output distribution from the teacher layer and the second output distribution from the student layer using back-propagation.

Example 19—The system of example 18, wherein the instructions, when executed by the processing circuitry, further configure the processing circuitry to: minimize a loss function that is a linear combination of KL-Loss and cross-entropy loss, using a hyperparameter to configure a weighting between the KL-Loss and the cross-entropy loss.

Example 20—Computer-readable storage media comprising instructions that, when executed, configure processing circuitry to: obtain input data for training an artificial intelligence model (AI model); provide the input data into a training framework having both a teacher layer providing target outputs and a student layer configured to learn to approximate the target outputs; train the AI model using the training framework, wherein to train the AI model includes the instructions, when executed, to further configure the processing circuitry to: define a quantizer that includes a clipping function and a rounding function to convert full-precision data derived from the input data to quantized data; determine a first output distribution for the input data from the teacher layer of the training framework using the full-precision data; determine a second output distribution for the input data from the student layer of the training framework using the quantized data; calculate a training loss between the first output distribution from the teacher layer and the second output distribution from the student layer; and modify training parameters of a quantized network of the student layer to reduce discretization error and prediction discrepancy between the quantized network of the student layer and a full-precision network of the teacher layer; generate new predictive output from the AI model using the quantized network of the student layer trained on the input data using the training framework; and output the predictive output.

Example 21—A computer program product comprising one or more instructions that, when executed by at least one processor, cause the at least one processor to perform any of the methods of examples 1-15.

Example 22—A device comprising means for performing any of the methods of examples 1-15.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A method comprising:
obtaining input data for training an artificial intelligence model (AI model);
providing the input data into a training framework having both a teacher layer providing target outputs and a student layer configured to learn to approximate the target outputs;
training the AI model using the training framework, wherein training the AI model includes:
defining a quantizer that includes a clipping function and a rounding function to convert full-precision data derived from the input data to quantized data;
determining a first output distribution for the input data from the teacher layer of the training framework using the full-precision data;
determining a second output distribution for the input data from the student layer of the training framework using the quantized data;
calculating a training loss between the first output distribution from the teacher layer and the second output distribution from the student layer; and
modifying training parameters of a quantized network of the student layer to reduce discretization error and prediction discrepancy between the quantized network of the student layer and a full-precision network of the teacher layer;
generating new predictive output from the AI model using the quantized network of the student layer trained on the input data using the training framework; and
outputting the predictive output.

2. The method of claim 1, further comprising:
providing the input data concurrently to the teacher layer and the student layer, wherein the teacher layer includes a full-precision network and further wherein the student layer includes a quantized network with less precision than the full-precision network of the teacher layer.

3. The method of claim 1, further comprising:
determining a Kullback-Leibler type divergence loss (KL-loss) between the first output distribution from the teacher layer and the second output distribution from the student layer; and
minimizing the KL-loss between the first output distribution from the teacher layer and the second output distribution from the student layer using back-propagation.

4. The method of claim 3, further comprising:
minimizing a loss function that is a linear combination of KL-Loss and cross-entropy loss, using a hyperparameter to configure a weighting between the KL-Loss and the cross-entropy loss.

5. The method of claim 3, wherein training the AI model using the training framework includes:
applying self-supervised knowledge distillation using weights of the student layer iteratively updated based on the KL-loss between the teacher layer and the student layer using the input data;
wherein the input data is unlabeled; and
wherein teacher layer weights remain fixed during the training the AI model using the training framework.

6. The method of claim 1, wherein the training framework implements a Self-Supervised Quantization-Aware Knowledge Distillation framework (SQAKD framework).

7. The method of claim 1, further comprising:
measuring a difference between the first output distribution from the teacher layer and the second output distribution from the student layer; and
training the student layer using transfer learning from the teacher layer including minimizing the training loss between the first output distribution from the teacher layer and the second output distribution from the student layer.

8. The method of claim 1, further comprising:
calculating the training loss between the first output distribution from the teacher layer and the second output distribution from the student layer;
wherein the training loss is defined as a linear combination of cross-entropy loss with labels and distillation losses between the first output distribution from the teacher layer and the second output distribution from the student layer.

9. The method of claim 8:
wherein the distillation losses between the first output distribution from the teacher layer and the second output distribution from the student layer represented by a term L are configurable using a hyperparameter a, according to:
$$L = ( 1 - λ ) {L}_{CE} + λ {L}_{Distill} ;$$
wherein L_{CE} represents Cross-Entropy Losses; and
wherein the distillation losses represented by a term L_{Distill} may be a single Kullback-Leibler divergence loss (KL-loss) or multiple intermediate-representation-based contrastive losses.

10. The method of claim 1:
wherein the quantizer, represented by Quant(⋅), applies the clipping function, represented by Clip(⋅), to restrict the full-precision data, represented by a term x, to a limited range to generate a full-precision latent representation, represented by a term x_{c}, according to:
$${x}_{c} = Clip ( x , {\{ {p}_{i} \}}_{i = 1}^{i = {K}_{c}} , v , m ) ;$$
wherein v represents a lower bound of the limited range;
wherein m represents an upper bound of the limited range;
wherein K_{c} represents a quantity of parameters; and
wherein
$${\{ {p}_{i} \}}_{i = 1}^{i = {K}_{c}}$$
denotes a set of trainable parameters used for quantization.

11. The method of claim 1, further comprising:
iteratively modifying the training parameters of the quantized network of the student layer to reduce discretization error and prediction discrepancy between the quantized network of the student layer and the full-precision network of the teacher layer; and
wherein the iterative modifying of the training parameters includes progressively reducing a bit width parameter using the rounding function of the quantizer to map full-precision data to smaller discrete quantization points, and wherein the iteratively modifying includes performing knowledge distillation over multiple stages or network layers of the student layer during the training.

12. The method of claim 1, further comprising:
applying back-propagation with gradient approximation to integrate discretization error to determine the training parameters configured to reduce the discretization error and the prediction discrepancy between the quantized network of the student layer and a full-precision network of the teacher layer.

13. The method of claim 12, further comprising:
applying the gradient approximation using a Straight-Through Estimator (STE) or using a modified STE to incorporate the discretization error.

14. The method of claim 12, further comprising:
determining the gradient approximation using the discretization error based on a difference between the full-precision data derived from the input data and the quantized data.

15. The method of claim 1, wherein training the AI model using the training framework includes:
applying self-supervised knowledge distillation using a temperature parameter to adjust the first output distribution for the input data from the teacher layer using the full-precision data; and
scaling logits of the first output distribution from the teacher layer and the second output from the student layer using the temperature parameter before calculating a KL-divergence loss between the first output distribution from the teacher layer and the second output distribution from the student layer to reduce variability within the first output distribution and the second output distribution.

16. A system comprising:
processing circuitry;
non-transitory computer readable media; and
instructions that, when executed by the processing circuitry, configure the processing circuitry to:
obtain, by the processing circuitry, input data for training an artificial intelligence model (AI model);
provide, by the processing circuitry, the input data into a training framework having both a teacher layer providing target outputs and a student layer configured to learn to approximate the target outputs;
train the AI model using the training framework, wherein to train the AI model includes the instructions, when executed, to further configure the processing circuitry to:
define, using the training framework, a quantizer that includes a clipping function and a rounding function to convert full-precision data derived from the input data to quantized data;
determine, using the training framework, a first output distribution for the input data from the teacher layer of the training framework using the full-precision data;
determine, using the training framework, a second output distribution for the input data from the student layer of the training framework using the quantized data;
calculate, using the training framework, a training loss between the first output distribution from the teacher layer and the second output distribution from the student layer; and
modify, using the training framework, training parameters of a quantized network of the student layer to reduce discretization error and prediction discrepancy between the quantized network of the student layer and a full-precision network of the teacher layer;
generate, by the processing circuitry, new predictive output from the AI model using the quantized network of the student layer trained on the input data using the training framework; and
output, by the processing circuitry, the predictive output.

17. The system of claim 16, wherein the instructions, when executed by the processing circuitry, further configure the processing circuitry to:
provide the input data concurrently to the teacher layer and the student layer, wherein the teacher layer includes a full-precision network and further wherein the student layer includes a quantized network with less precision than the full-precision network of the teacher layer.

18. The system of claim 16, wherein the instructions, when executed by the processing circuitry, further configure the processing circuitry to:
determine a Kullback-Leibler type divergence loss (KL-loss) between the first output distribution from the teacher layer and the second output distribution from the student layer; and
minimize the KL-loss between the first output distribution from the teacher layer and the second output distribution from the student layer using back-propagation.

19. The system of claim 18, wherein the instructions, when executed by the processing circuitry, further configure the processing circuitry to:
minimize a loss function that is a linear combination of KL-Loss and cross-entropy loss, using a hyperparameter to configure a weighting between the KL-Loss and the cross-entropy loss.

20. Computer-readable storage media comprising instructions that, when executed, configure processing circuitry to:
obtain input data for training an artificial intelligence model (AI model);
provide the input data into a training framework having both a teacher layer providing target outputs and a student layer configured to learn to approximate the target outputs;
train the AI model using the training framework, wherein to train the AI model includes the instructions, when executed, to further configure the processing circuitry to:
define a quantizer that includes a clipping function and a rounding function to convert full-precision data derived from the input data to quantized data;
determine a first output distribution for the input data from the teacher layer of the training framework using the full-precision data;
determine a second output distribution for the input data from the student layer of the training framework using the quantized data;
calculate a training loss between the first output distribution from the teacher layer and the second output distribution from the student layer; and
modify training parameters of a quantized network of the student layer to reduce discretization error and prediction discrepancy between the quantized network of the student layer and a full-precision network of the teacher layer;
generate new predictive output from the AI model using the quantized network of the student layer trained on the input data using the training framework; and
output the predictive output.
